(19) United States
(12) Patent Application Publication
(10) Pub. No.: US 2026/0268421 A1
(43) Pub. Date: Sep. 10, 2026

(54) SYSTEMS AND METHODS FOR COMMUNICATING BEVERAGE RECIPES TO A NETWORK OF BEVERAGE ROBOTS

(71) Applicant: BOTRISTA, INC., San Francisco, CA (US)

(72) Inventors: Wu-Chou KUO, San Francisco, CA (US); Yu-Wei CHEN, New Taipei City (TW)

(21) Appl. No.: 19/075,647

(22) Filed: Mar. 10, 2025

(51) Int. Cl. G06Q 50/12; A47J 31/00; A47J 31/60; B25J 11/00; B67D 1/00; B67D 1/07; G06Q 10/087; G06Q 30/0201; G06Q 30/08; G06F 3/0482

(52) U.S. Cl. CPC G06Q 50/12; A47J 31/002; A47J 31/60; B25J 11/0045; B67D 1/0015; B67D 1/07; G06Q 10/087; G06Q 30/02013; G06Q 30/08; G06F 3/0482

(57) ABSTRACT

Beverage platforms for brands and vendors, and associated systems, devices, and methods are disclosed herein. In some embodiments, a method for operating a network of production robots includes receiving, from a recipe generator, a preparation recipe associated with a beverage from the recipe generator, generating robot operating procedures based on the received preparation recipe, identifying one or more beverage-generating locations available to prepare the beverage based on ingredients available at individual beverage robots at each of the one or more beverage-generating locations, receiving, from the recipe generator, a selection of a beverage-generating location, and communicating the generated robot operating procedures to at least one beverage robot at the selected beverage-generating location to allow the at least one beverage robot to prepare the beverage according to the preparation recipe.

### TECHNICAL FIELD

The present technology is generally directed to virtual platforms for beverage brands and stores, and associated systems, devices, and methods.

### BACKGROUND

Freshly made beverages are typically more desirable to consumers than factory-produced, canned, or bottled beverages. For example, freshly made beverages can have superior taste, freshness, and/or customizability in the ingredients used in the beverage. Accordingly, restaurants, cafés, coffee shops, and/or other beverage vendors prefer to offer a menu of freshly made beverages. The fresh preparation, however, typically requires the time and attention of vendor personnel, which can slow down order production, causing customer dissatisfaction, reducing the volume of orders vendors can produce, and/or increasing the costs per order. Preparing fresh beverages also requires increased attention to avoid fresh ingredients surpassing their shelf-life and to avoid spoilage and/or other degradation of the beverage ingredients. To meet these challenges, vendors have increasingly automated portions, or all, of the production of beverages.

Automation brings about another set of challenges. For example, automating beverage productions requires that vendors be able to maintain, diagnose, and fix the automation systems. Additionally, vendors must be able to track and monitor ingredients and ingredient inventory for the automated systems to avoid preparing contaminated drinks. Still further, vendors must be able to track orders through the automated system to ensure customer satisfaction with the timing, resulting orders, and overall experience.

### BRIEF DESCRIPTION OF THE DRAWINGS

FIG. 1 is a schematic diagram of a system for operating food and/or beverage robots in accordance with some embodiments of the present technology.

FIG. 2 is a schematic network diagram of a system for operating a network of food and/or beverage robots in accordance with some embodiments of the present technology.

FIG. 3 is a block diagram of a platform for operating a network of beverage robots in accordance with some embodiments of the present technology.

FIG. 4 is a block diagram of a subsystem for a beverage robot in accordance with some embodiments of the present technology.

FIG. 5 is a schematic front view of a beverage robot configured in accordance with some embodiments of the present technology.

FIG. 6 is a schematic block diagram illustrating a beverage matching system configured in accordance with embodiments of the present technology.

FIGS. 7–9 illustrate a series of user interfaces from a beverage brand perspective, configured in accordance with embodiments of the present technology.

FIGS. 10–13 illustrate a series of user interfaces from a beverage store perspective, configured in accordance with embodiments of the present technology.

FIG. 14 is a schematic block diagram illustrating a beverage bidding system configured in accordance with embodiments of the present technology.

FIG. 15 is a flow diagram illustrating a method for matching beverage brands with beverage vendors in accordance with embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described.

### DETAILED DESCRIPTION

### I.Overview

A beverage matching system for matching beverage brands with beverage vendors, and associated systems, devices, and methods are disclosed herein. Beverage brands have recipes for creating specific beverages while beverage vendors operate stores that sell beverages to customers, so beverage brands and beverage vendors are constantly seeking each other to help drive their businesses. As discussed in more detail below, for example, embodiments of the present technology include processes related to guiding beverage brands and/or beverage vendors in identifying and applying to vendors and brands that they want to match with, respectively, and once a match is made, efficiently sharing information between the matched beverage brand and beverage vendor to launch the partnership. Processes may also relate to facilitating a bidding system in which beverage brands and beverage vendors each bid amongst themselves to match with high-performing beverage vendors and beverage brands, respectively. The processes can be implemented by a virtual platform on which beverage brands and beverage vendors can sort through various statistics and other forms of information about one another, receive match recommendations, review competitors, and apply for a partnership. Once a match is made (e.g., upon the vendor or brand accepting a partnership application), the virtual platform can coordinate with the matched beverage brand and beverage vendor to launch the partnership, such as by coordinating marketing, shipping, etc.

Conventionally, it can be a complex and costly endeavor for beverage brands to expand. For example, brands may not want to expend resources to sell their beverages at low-performing stores, and choosing store locations can involve considering market demand, availability of store space, budget constraints, operational layout suitability, non-compete policies, bidding processes (e.g., for selling at stadiums), etc. As another example, given the high turnover rate of employees in the food and beverage industry (e.g., estimated to be about 75%, or 1.5x the turnover rate in the private sector), brands and stores alike are pressured to expend resources on employee training and quality assurance. As yet another example, brands must consider their supply chain when expanding, and supply chain management can be a complex effort requiring daily tasks such as inventory management, quality assurance, and other manual tasks.

When brands and stores are seeking to form partnerships, they must go through an extensive, time-consuming, and costly process. For example, brands and stores must acquire information on (i) what stores or brands are available and/or willing to form partnerships, (ii) which of those stores or brands are willing to form partnerships, (iii) which competitors are selling at which location(s), (iv) consumer demand (current and anticipated), and/or the like. Even after a brand and store express mutual interest in a partnership, the brand and store must (i) set terms and conditions, (ii) monitor sales over time, and/or the like. Still further, there are numerous technical challenges associated with identifying and working with stores that have beverage robots or brands that have beverages capable of being prepared by the beverage robots. For example, a network of available stores can be vast, requiring extensive research from a brand to filter through to identify relevant stores. As another example, (i) brands must identify which stores have the ingredient inventory available to prepare their beverages (and/or available storage for the ingredients necessary to prepare the beverages); (ii) stores must identify brands with beverages they can prepare based on the ingredients available at each of their beverage robots; and (iii) brands and stores must be able to communicate recipes, operational requirements, expectations, etc. with one another to ensure consistency in the preparation of the beverages.

Further, once partnerships are formed, from a beverage brand’s perspective, it can be difficult and costly to ensure that all of the stores through which the brand sells its beverages are producing consistent, high quality beverages in line with their recipe and reputation. This difficulty can be exacerbated by turnover in the workforce at the store after the partnership is formed. From a store’s perspective, it can be difficult and costly to track the performance of different beverage brands and to anticipate what other and/or new beverage brands would perform better, ensure that staff are complying with the terms and conditions and operational requirements set forth in partnership agreements, etc.

Embodiments of the present technology address some of the above-mentioned issues, such as by helping brands and vendors match more efficiently and effectively, sharing information such as recipes and operational requirements more smoothly, and incentivizing brands and vendors to perform at higher levels. For example, embodiments of the present technology include a method for matching a beverage brand with a beverage vendor. The method can include receiving, from the beverage brand, ingredient management details and a beverage production recipe. The ingredient management details can include supplier information, ingredient information, and end product information, wherein the beverage production recipe specifies steps for producing a beverage. The method can include filtering beverage vendors who do not match a profile compatible with the beverage brand and/or who may not be able to comply with the requirements set forth in the received ingredient management details and the beverage production recipe, thus saving beverage brands resources in identifying suitable partners. The filtering can be based on metadata associated with the stores. The metadata can include a category of the store (e.g., cafes, coffee shops, bars, restaurants, theaters, and/or the like), categories of the beverages sold (e.g., coffee, tea, boba, alcoholic beverages, specialty drinks, and/or the like), hours of operation (e.g., morning, evening, nighttime), geographical location (e.g., downtown, suburbs), demographic information around the store, age restrictions (e.g., 21 and over), liquor licenses held, etc. Additionally, or alternatively, the filtering can be based on information on ingredients available at the beverage vendors and/or other suitable information. The method can include generating recommendations for beverage brands and beverage vendors on which vendors or brands, respectively, they should partner with.

The method can also include generating robot operating procedures based on the received beverage production recipe. The robot operating procedures can comprise operating instructions for a beverage robot to produce the beverage according to the received beverage production recipe. The method can further comprise receiving, from the beverage brand, a set of operating guidelines, matching the beverage brand with the beverage vendor, communicating, to the matched beverage vendor, the ingredient management details and the set of operating guidelines, and communicating, to a beverage robot at the matched beverage vendor, the generated robot operating procedures. In some embodiments, the method includes generating both robot operation procedures and human operating procedures based on the received beverage production recipe. For example, a first set of steps of the recipe may be delegated to a beverage robot while a second set of steps of the recipe may be delegated to a staff or employee working at the vendor.

The method can further include communicating and/or confirming compliance to operational instructions that specify where ingredients should be sourced from, when beverage robots need to be refilled with ingredients, ingredient storing conditions, how often the beverage robots need to undergo cleaning or maintenance, and/or the like. Ensuring consistency in the produced branded beverages allows brands to be matched with vendors irrespective of geographical location, language barriers, etc. and to share recipes from brands across different stores.

Embodiments of the present technology can be implemented on a virtual platform that may be part of a remote (e.g., cloud-based) system. The virtual platform can foster a dynamic ecosystem in which brands and stores collaborate strategically, benefitting brands, stores, and consumers. For brands, the virtual platform can (i) simplify the new store launch process by leveraging streamlined operations and automated tools, (ii) help brands expand rapidly to desired locations with integrated map views and recommendations for ideal locations, (iii) maintain strict control over beverage quality through standardized processes and the beverage production precision of the beverage robots, (iv) increase brand awareness nationwide by consistently delivering high-quality beverages and engaging marketing materials, and (v) boost beverage revenue by leveraging data-driven insights for strategic decision-making and optimizing operations.

For stores, the virtual platform can (i) allow the stores to prepare the branded beverages with a consistent flavor profile and/or quality to meet customer expectations when ordering the branded beverages, (ii) provide exceptional customer service and experiences to build loyalty and encourage continued business, (iii) utilize marketing resources and support to promote the brand’s arrival and generate interest in the local community, (iv) enhance beverage revenue by offering high-quality branded beverages that meet customer expectations, and (v) leverage the brand’s reputation to attract more consumers and increase foot traffic.

For consumers, the virtual platform can (i) help ensure consistency in beverages ordered at a variety of store locations, (ii) meet changing consumer demands for different beverages by introducing popular beverages at local stores rapidly, and (iii) introduce consumers to new brands expected to be popular based on demographics and other information.

In the figures, identical reference numbers identify generally similar, and/or identical, elements. Many of the details, dimensions, and other features shown in the figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### II.Examples of Suitable Systems for Operating Food and/or Beverage Robots in Accordance with Embodiments of the Present Technology

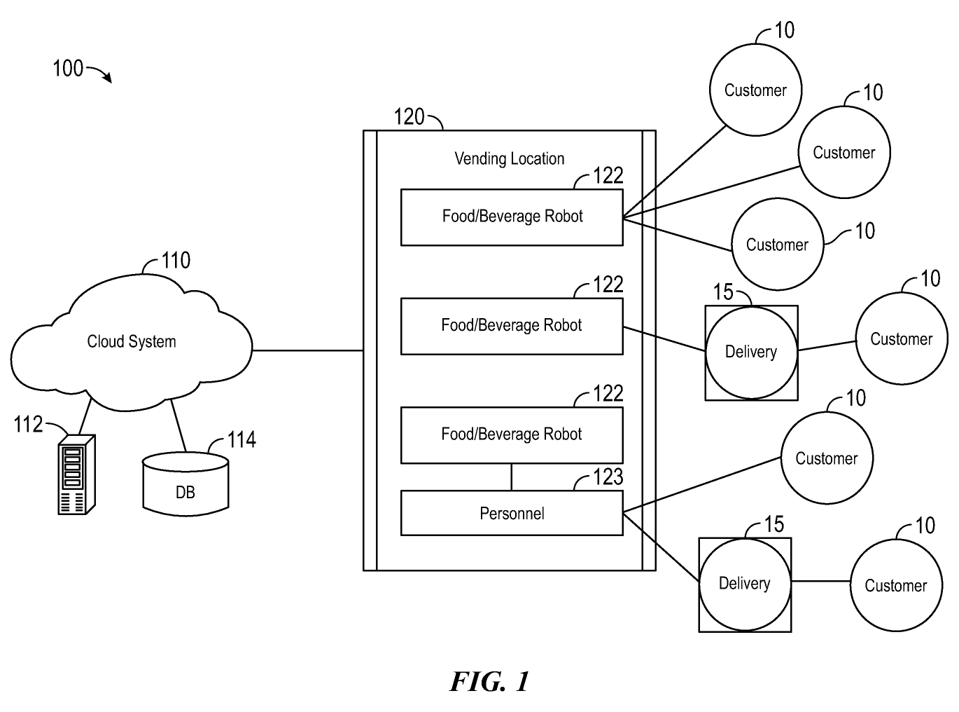

FIG. 1 is a schematic diagram of a system 100 for operating food and/or beverage robots in accordance with some embodiments of the present technology. The system 100 can interconnect a remote system 110 with one or more vending locations 120 (one illustrated in FIG. 1) to operate one or more food/beverage robots 122 (three illustrated in FIG. 1) at each of the vending location(s) 120. As discussed in more detail below, the food/beverage robots 122 can automate the preparation of various food items and/or beverages for customers 10 at the vending location(s) 120. The food items and/or beverages can then be provided directly to the customers 10, to delivery personnel 15 to provide to the customers (e.g., delivery drivers), and/or to personnel 123 at the vending location (e.g., staff such as baristas, waiting staff, food runners, bar tenders, and/or the like) to provide to the customers 10 and/or delivery personnel 15. The automation at the vending locations 120 can allow the vending location(s) 120 to provide a wider variety of food items and/or beverages, increase the number of the customers 10 the vending location(s) 120 can serve, improve consistency in the taste of the food items and/or beverages, and/or increase transparency into a status of an order and/or an estimated completion time for the order.

As illustrated in FIG. 1, the remote system 110 can include one or more servers 112 (one illustrated in FIG. 1) as well as one or more databases 114 (one illustrated in FIG. 1). The server(s) 112 can be an edge server and/or a cloud-based server with one or more server computing devices configured to perform various operations in support of the food/beverage robots 122. Purely by way of example, as discussed in more detail below, the server(s) 112 can manage orders for food/beverages, queue orders between different sets of the food/beverage robots 122 and/or between different vending location(s) 120, manage and/or monitor food/beverage ingredients, monitor the operation of the food/beverage robots 122 (e.g., check cleaning status, monitor for part malfunctions, predict and/or schedule maintenance, and/or the like), maintain and/or share food/beverage recipes, modify recipes to account for variances in ingredients, and/or the like. The server(s) 112 can include various hardware, such as processing units (e.g., GPUs, CPUs, APUs, and/or the like), working memory, storage memory, input/output devices, displays (e.g., LCD display screens, LED display screens, OLED display screens, and/or the like), a network card, video card, audio card, USB ports, and/or the like. Further, the server(s) 112 are illustrated as a single server, the server(s) 112 can each be a distributed computing environment encompassing multiple computing devices located at the same or at geographically disparate physical locations. Further, the server(s) 112 can correspond to a group of servers supporting the food/beverage robots 122.

The database(s) 114 can warehouse (e.g., store) information, such as drink recipes, lot information or ingredients, stocking keeping units (SKU) information, part information, and/or the like. Though database(s) 114 is illustrated as a single unit, the database(s) 114 can each be a distributed computing environment encompassing multiple computing devices, can be located within one of the server(s) 112 (and/or within a computing device of the server(s) 112), or can be located at the same or at geographically disparate physical locations. The database(s) 114 can include one or more memories, each of which can include various hardware devices for volatile and non-volatile storage. For example, the memory can comprise random access memory (RAM), various caches, CPU registers, read-only memory (ROM), and writable non-volatile memory, such as flash memory, hard drives, CDs, flash drives, magnetic storage devices, and/or the like. The memory is not a propagating signal divorced from underlying hardware; the memory is thus non-transitory. Further, the memory can include sections, such as a program memory section that stores programs and software related to the operation of the food/beverage robots 122 and/or a data memory section that stores data related to the operation of the food/beverage robots 122.

The remote system 110 can be communicatively coupled to various computing devices at the vending location(s) 120 through a network connection (e.g., an internet connection, cellular network, and/or the like). For example, the communication can be implemented through the network using TCP/IP protocols, a Q-LAN protocol, or others. In a specific, non-limiting example, each of the food/beverage robots 122 can include computing components that allow the food/beverage robots 122 to communicate individually (or collectively) with the remote system 110 and/or various other computing devices at the vending location(s) 120 (e.g., point-of-sale systems, on-site servers, and/or the like).

As discussed in more detail below, the communication can allow the remote system 110 to support and/or control (partially or fully) various operations of the food/beverage robots 122 and/or various related operations. For example, the vending location(s) 120 can be any location that serves food items and/or beverages (e.g., a store, café, coffee shop, tea shop, restaurant, food truck, brewery, bar, hotel, resort, conference center, stadium, entertainment center (e.g., a theater, music venue, arcade, bowling center, pool hall, theme park, and/or the like), and/or any other suitable location). The remote system 110 can communicate with the food/beverage robots 122 in the vending location(s) 120 to store and/or communicate recipes for orders; monitor ingredients available at the food/beverage robots 122; assign orders (or portions thereof) to the food/beverage robots 122; time the completion of orders based on other aspects of the order, a location of the customers 10, a location of a delivery person, and/or the like; monitor a cleaning and/or health status of the food/beverage robots 122; and/or any other suitable operation.

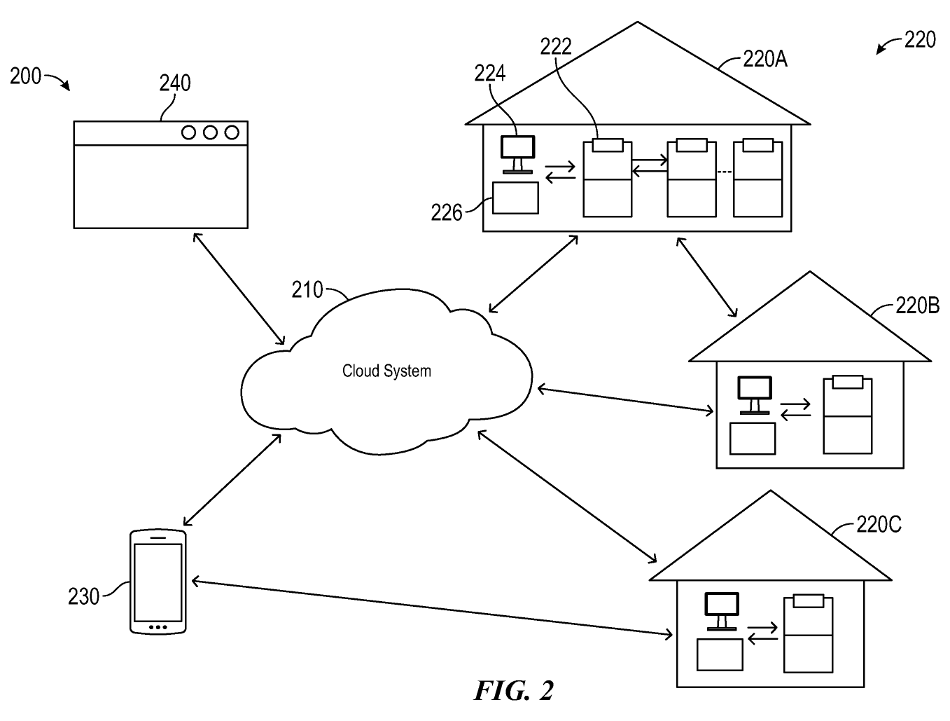

FIG. 2 is a schematic network diagram of an environment in which embodiments of the present technology can operate. The environment can include a remote system 210 (e.g., a cloud computing system) generally similar (or identical) to the remote system 110 discussed above with respect to FIG. 1. For example, the remote system 210 can include one or more servers (e.g., the servers of FIG. 1) as well as one or more databases (e.g., the databases 114 of FIG. 1) that allow the remote system 210 to support and/or facilitate various operations in the environment 200. As further illustrated in FIG. 2, the environment 200 can also include one or more vending locations 220 (three illustrated in FIG. 2, referred to individually as first–third vending locations 220A–220C), one or more client computing devices 230 (one illustrated in FIG. 2), and one or more third-party platforms 240 (one illustrated in FIG. 2). As further illustrated in FIG. 2, the vending locations 220, client computing devices 230, and third-party platforms 240 are each communicatively coupled to the remote system 210 (e.g., via a network connection). As a result, as discussed in more detail below, the remote system 210 can help support, facilitate, and/or control operations at each of the vending locations 220, the client computing devices 230, and/or the third-party platforms 240. Additionally, or alternatively, the remote system 210 can provide a connection and/or facilitate communications between the vending locations 220, the client computing devices 230, and/or the third-party platforms 240.

Similar to the discussion above, the vending locations 220 can include any location providing food and/or beverage sales to customers. In a non-limiting example, the first vending location 220A can be a restaurant, the second vending location 220B can be a food truck, and the third vending location 220C can be a coffee shop. Further, each of the vending locations 220 can include one or more food/beverage robots 222, a point-of-sale (POS) system 224, and/or onsite computing system 226. The food/beverage robots 222, the POS system 224, and the onsite computing system 226 can be communicably coupled by a network (e.g., the internet, a local area network (LAN), a wide area network (WAN), and/or the like), one or more wired connections, and/or various shortrange wireless communication components (e.g., Bluetooth®, Zigbee®, Z-Wave®, HaLow®, Wi-Fi, NearLink, near-field communication (NFC), low-power WAN, ultra-wideband (UWB), and/or the like). As a result, the food/beverage robots 222, the POS system 224, and the onsite computing system 226 can help partially (or fully) automate transactions and the production of orders received at each of the vending locations 220.

For example, as discussed in more detail below, the food/beverage robots 222 can store and/or have access to any suitable number of ingredients and automate the preparation of various food items and/or beverages. Purely by way of example, the food/beverage robots 222 can store a plurality of bag-in-boxes (BIBs) that each has concentrated ingredients for various different beverages (e.g., juice blends, sodas, teas, boba drinks, coffee drinks, energy drinks, matés, milk drinks, milkshakes, lemonades, flavored water, flavored sparkling water, mocktails, probiotic drinks, and/or the like). The food/beverage robots 222 can access one or more of the BIBs in response to an order and automatically mix the ingredients to prepare one or more beverages in the order. The POS system 224 can include various devices to receive and process transactions and generate orders for the food/beverage robots 222. For example, the POS system 224 can include cash registers, electronic terminals (e.g., touchscreen terminals), virtual terminals (e.g., accessible through an app on a customer’s phone, a web browser, and/or the like), credit card readers, chip readers, and/or the like. Once a transaction is processed, for example, the POS system 224 can send the order(s) associated with the transaction to the food/beverage robots 222 to be prepared. The onsite computing system 226 can include desktop computers, laptops, server computing devices, databases and other storage devices, and/or the like to provide computational services (e.g., order processing, order distribution, order management, order change requests, recipe management, ingredient management, maintenance scheduling, cleaning scheduling, quality control, and/or the like) for the POS system 224 and/or the food/beverage robots 222. Said another way, the onsite computing system 226 can provide local services that support the operations discussed herein as additional, or peripheral, computing devices to the remote system 210.

The client computing devices 230 can include wireless smartphones, wireless tablets, desktop computers and other computer systems (e.g., server computers), wireless laptops, digital assistants, virtual assistants, other smart devices (e.g., smart watches, smart glasses, and/or the like), internet-of-things (IoT) devices, and/or the like. The client computing devices 230 allow users (e.g., customers, vending location personnel, maintenance personnel, brand personnel, and/or the like) to access different components of the environment 200. For example, a customer can access the remote system 210 and/or the POS system 224 in any of the vending locations 220 through their smartphone to place an order. In another example, a manager at one of the vending locations 220 can access the remote system 210 and/or the food/beverage robots 222, the POS system 224, and/or the onsite computing system 226 through a laptop computer to monitor information on the vending locations 220 (e.g., stock levels for the ingredients, maintenance warnings/schedules, cleaning schedules, order history, order trends, and/or the like).

The third-party platforms 240 can be implemented on various suitable computing devices and/or systems (e.g., server computing systems, laptop computers, desktop computers, smart devices, and/or the like). The third-party platforms 240 can provide peripheral services to the remote system 210 and/or any of the other components in the environment 200. Purely by way of example, the third-party systems can include a sales, marketing, and deployment tracking platform (e.g., ClickUp and/or the like) that helps the remote system 210 monitor the deployment of the food/beverage robots 222, sales across the environment 200, and/or the like. Additionally, or alternatively, the sales, marketing, and deployment tracking platform can help any of the vending locations 220 monitor the deployment of the food/beverage robots 222, track their sales, market their food/beverage options, and/or the like.

In another example, the third-party platforms 240 can include a data visualization and analytics platform (e.g., Tableau, Looker, and/or the like). The data visualization and analytics platform can work with raw data from the remote system 210 and/or any of the vending locations 220 (or any specific components therein) to summarize and/or analyze the data. In a specific, non-limiting example, the data visualization and analytics platform can identify sales trends in the data for the remote system 210, allowing the remote system 210 to make recommendations to the vending locations 220 on what ingredients to stock, popular recipe trends, recipes trends specific to the vending location area and/or type, and/or the like. Additionally, or alternatively, the data visualization and analytics platform can record data on needed maintenance, maintenance schedules, cleaning schedules, and/or the like to help the remote system 210 and/or the vending locations 220 track the status of the food/beverage robots 222.

In yet another example, the third-party platforms 240 can include a customer support platform (e.g., Freshdesk and/or the like). The customer support platform can supplement (or provide) a service dashboard in the remote system 210 to help the remote system 210 provide services to the vending locations 220. In a specific, non-limiting example, the customer support platform can use the raw data (and/or analyses from the data visualization and analytics platform) to respond to calls from the vending locations 220 regarding the status of the food/beverage robots 222. Further, the customer support platform can help proactively monitor and manage the health of the food/beverage robots 222 (e.g., using data from the data visualization and analytics platform to schedule maintenance ahead of a breakdown). Additionally, or alternatively, the vending locations 220 can be connected to the customer support platform through the remote system 210 to provide customer support at the vending locations (e.g., answer questions about transactions, complaints about orders, suggestions for the vending locations 220, issue refunds, and/or the like).

In yet another example, the third-party platforms 240 can include an enterprise resource planning (ERP) platform. The ERP platform can help the remote system 210 and/or the vending locations 220 manage invoices, orders, inventory, and/or the like. In a specific, non-limiting example, the remote system 210 can be integrated with the ERP platform to track SKU information on the ingredients used in each of the food/beverage robots 222 to alert the vending locations 220 and/or automatically order additional inventory when the ingredients are low. Additionally, or alternatively, the vending locations 220 can access the ERP platform to help track the invoices associated with ingredients they order, and/or the like.

In yet another example, the third-party platforms 240 can include a third-party logistics (3PL) platform (e.g., Logiwa). The 3PL platform can help the remote system 210 manage warehouse and shipping logistics to provide and/or install the food/beverage robots 222 in the vending locations 220, provide and/or install parts for the food/beverage robots 222, provide ingredients for the vending locations 220, and/or the like. Additionally, or alternatively, the 3PL platform can help the remote system 210 manage various special orders (e.g., modifications to customize the food/beverage robots 222 to any of the vending locations 220, customized ingredient orders, and/or the like) from the vending locations 220.

Although discussed above as being connected through the remote system 210, the vending locations 220, the client devices 230, and/or the third-party platforms 240 can communicate directly. For example, as illustrated in FIG. 2, the first vending location 220A can directly communicate with the second vending location 220B. The direct communication can allow, for example, the first and second vending locations 220A, 220B to share orders (or portions thereof) independent from control and/or supervision from the remote system 210. The direct communication and independent control, in turn, can reduce the resources required in the remote system 210 to support the operation of the first and second vending locations 220A, 220B. In another example, the client computing device 230 can communicate directly with the third vending location 220C. The direct communication can allow, for example, the third vending location 220C to receive order(s) directly from the client computing device 230, without any delays relaying the order through the remote system 210.

Further, although the vending locations 220 are illustrated in FIG. 2 as each having at least one of the food/beverage robots 222, the POS system 224, and the onsite computing system 226, it will be understood that the systems and methods disclosed herein are not so limited. For example, any of the vending locations 220 can omit the food/beverage robots 222 and instead communicate with another of the vending locations 220 (directly or through the remote server) to produce orders. In another example, any of the vending locations 220 can omit the POS system 224 and/or the onsite computing system 226. Instead, the remote system 210 can receive, distribute, manage, and/or track orders on behalf of the vending locations 220 and/or provide any necessary computational services.

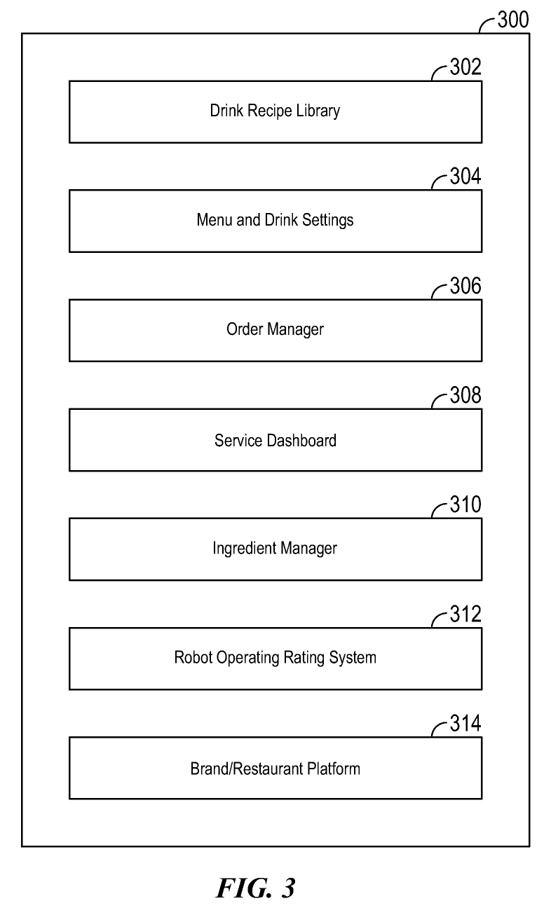

FIG. 3 is a block diagram of a platform 300 for operating a network of beverage robots in accordance with some embodiments of the present technology. The platform 300 can be implemented in one or more computing devices, such as the remote system 210 discussed above with reference to FIG. 2, to help support, manage, and/or control operations in a variety of vending locations. For example, the platform 300 can be implemented on one or more processors of a computing system with access to any suitable number of storage components to facilitate the operations of the platform 300 as described herein. Further, as illustrated in FIG. 3, the platform 300 can include one or more modules (seven illustrated in FIG. 3, referred to individually as first–seventh modules 302–314), various examples of which are discussed in more detail below.

The first module 302 can include a drink recipe library. The drink recipe library can include information on the proportions of ingredients for a variety of beverages, such as juice blends, sodas, teas, boba drinks, coffee drinks, energy drinks, matés, milk drinks, milkshakes, lemonades, flavored water, flavored sparkling water, mocktails, probiotic drinks, and/or the like. In some embodiments, the recipes include specific ratios (e.g., percentages of different ingredients such as 5% a first juice, 5% a second juice, 1% simple syrup, 40% ice, and 39% water; ratios of ingredients such as 1 part tea concentrate, 0.5 parts ice, 1 part water; and/or the like). Additionally, or alternatively, the recipes can include various nutrient tables, acidity information, sweetness information, concentration information, and/or the like related to how a beverage should taste. In such embodiments, the drink recipe library can allow beverage robots to vary the exact ratios of ingredients to account for variations in the ingredients (e.g., using more or less of a juice concentrate based on variations in different batches, using more or less simple syrup to compensate for variations in the acidity of batches of coffee concentrate, and/or the like). Further, the drink recipe library can have recipes that allow beverage robots to produce beverages of any size, beverages in a range of sizes (e.g., common sizes such as 16 ounces (oz), 20 oz, 24 oz, and/or the like), and/or only beverages of a specified size (e.g., 16 oz of an energy drink to limit the caffeine provided in a single beverage).

Still further, the drink recipe library in the first module 302 can include a variety of generic recipes, a list of previously customized recipes, branded recipes, and/or the like. The generic recipes can be baseline recipe suggestions for a variety of drinks that a vending location can customize based on taste preferences and/or customer feedback. Any customized recipe can then be stored to be accessed, used, and/or customized by other vending locations. The branded recipes can be specific to drink and/or beverage brands (e.g., juice brands, sports drink brands, coffee brands, tea brands, soda brands, energy drink brands, health drink brands, smoothie brands, milkshake brands, and/or the like) and/or specific to vending locations (e.g., specific to stores of a specific a franchise name). The first module 302 (and/or a related module) can advertise the availability of the branded drinks but restrict access to the recipes until approved by the brand. For example, the first module 302 can require a vending location to pay an upfront fee and/or royalties to access a branded recipe. In another example, the first module 302 can allow a brand to review an access request to control where their branded drinks are available and/or check for quality control at the vending locations requesting access. Additionally, or alternatively, the first module 302 can monitor customized recipes for imitations of branded recipes to help prevent vending locations from copying branded drinks after accessing them once.

The second module 304 can help generate menu and drink settings for a vending location. For example, the second module 304 can keep track of the required ingredients for recipes as a vending location builds a menu, prevent the vending location from selecting recipes requiring additional ingredients once they reach a limit on the ingredients the beverage robots can store, and/or suggest additional beverages based on the ingredients at the vending location (e.g., other beverages that can be created without additional ingredients). Additionally, or alternatively, the second module 304 can use information about the vending location (e.g., restaurant type, sales in a surrounding area, demographic information around the vending location, seasonal information, and/or the like) to suggest recipes for the menu. Purely by way of example, the second module 304 can recommend that a pizza restaurant stock ingredients for lemonade, sodas, sports drinks, and/or the like based on those beverages typically selling well with pizza. In another example, the second module 304 can recommend a vending location near a university to stock ingredients for coffee, energy drinks, and/or the like based on demographic information for the vending location. Still further, once a vending location has selected recipes for their beverage robot(s), the second module 304 can generate a menu (e.g., a user interface for a virtual menu) with the recipes and provide the menu to the vending location POS and/or the beverage robot.

The third module 306 can provide an order manager to one or more vending locations. The order manager can queue orders (or individual beverages from orders) to be produced by the beverage robot(s). For example, the order manager can determine which beverage robot in a café will be able to produce an order fastest based on existing queues at each beverage robot in the café, then add the order to the queue at the chosen beverage robot. In some embodiments, orders are scheduled based on estimated completion times and estimated pick-up times. For example, when a customer orders through an app on their phone, the order manager can estimate when they will arrive at the café and delay the production of their order until closer to the arrival time. As a result, the order will be fresher when picked up than if the order had been queued and produced when received. In another example, the order manager can receive a take-out/delivery order for a beverage from a first restaurant, determine that a second restaurant can provide the beverage to the customer sooner, and present the customer with the option to receive the beverage from the second restaurant. By producing the order from a recipe with a beverage robot, the customer can then receive the same drink (as customized to the first restaurant) from the second restaurant. Further, the first and second restaurants can expand their sales by making the beverages more convenient/quicker to receive. In yet another example, the order manager can track the status of an order throughout the production process (e.g., by monitoring the position in the queue(s)) to provide customers with a real-time, accurate prediction of when their order will be complete. The increased transparency can increase customer satisfaction, particularly during busy times at a vending location. In yet another example, the order manager can receive customizations and/or order changes. Further, because the order manager can track the status of an order through production, the order manager can allow a customer to seamlessly make changes to their order until the order is prepared by the beverage robot(s).

The fourth module 308 can provide a service dashboard for vending location personnel and/or personnel associated with the beverage robots. The service dashboard can provide a record of statistics and data from the beverage robots (e.g., past and scheduled maintenance, health status of beverage robots, cleaning status of beverage robots, usage of beverage robots, and/or the like). In a specific, non-limiting example, the service dashboard can show that one or more tubes in a beverage robot are locked, along with an error code explaining why they are locked (e.g., spoiled ingredients, required cleaning, connection malfunction, and/or the like). As a result, the service dashboard can allow personnel associated with the beverage robots to respond to inquiries from vending locations and/or guide them through correcting the error. Additionally, or alternatively, the service dashboard can allow vending location personnel to address issues without contact with other maintenance personnel. In some embodiments, the service dashboard in the fourth module 308 can communicate with one or more additional modules (e.g., the sixth module 312 discussed in more detail below) to provide information related to the health status of beverage robots, cleaning data related to the beverage robots, usage of the beverage robots, and/or the like.

The fifth module 310 can include an ingredient manager. The ingredient manager can receive SKU information for shipments to vending locations and ingredient packages (e.g., BIBs) as they are used by the beverage robots. The ingredient manager can use the SKU information to track ingredient consumption in vending locations. Additionally, or alternatively, the ingredient manager can track and/or identify ingredients from specific batches (e.g., to prompt the first module 302 to adjust a recipe for variations between batches, identify recalled batches, and/or the like). Further, the ingredient manager can track ingredient expiration dates (e.g., milk and other spoilable ingredients) and prompt vending locations to replace ingredients close to their expiration. Still further, the ingredient manager can receive information from one or more sensors in the beverage robots related to ingredients remaining in a package (e.g., dispensing information, weight measurements, volume measurements, and/or the like) to help track and manage inventory for a vending location. The ingredient manager can then prompt a vending location to replace (or plan to replace) empty packages in the beverage robots, order more packages as their inventory goes down, and/or the like. In some embodiments, the ingredient manager automatically manages inventory (e.g., tracks and orders inventory) for a vending location to make sure they are stocked on ingredients. In some such embodiments, the ingredient manager accounts for sales trends, sales forecasts, and/or the like while managing inventory. Purely by way of example, the ingredient manager can stock additional ingredients for cold beverages ahead of a heat wave in anticipation of increased sales to make sure the vending location has adequate inventory.

The sixth module 312 includes a robot operating rating system. The robot operating rating system can use data from beverage robots at a vending location to evaluate and/or grade the vending location. For example, the robot operating rating system can consider data related to cleaning cycles and cleaning times of the beverage robots, error codes and responses to error codes, employee certification and training, inventory management from vending locations, shelf-life management from vending locations, and/or the like. The data can then be used to generate food safety ratings, grade the operation of the beverage robots, improve quality control for the operation of the beverage robots, and/or the like. The sixth module 312 can then use the ratings to adjust maintenance schedules for the beverage robots (e.g., increase maintenance when vending locations do not respond well to error codes), adjust the operation of the beverage robots (e.g., prevent robots from dispensing spoiled ingredients), and/or provide the ratings to franchise owners and/or brands to help monitor the vending locations for quality control.

The seventh module 314 can provide a platform for brands/vending locations to market themselves and/or interact. For example, brands can create beverage recipes that they market through the seventh module. Vending locations can review available brands as they generate (or refresh) their menu offerings, then contract with the brands through the seventh module 314. Additionally, or alternatively, brands can contact vending locations through the seventh module to place their beverages in a variety of locations. Further, the seventh module 314 can communicate with various other modules on the platform 300. Purely by way of example, the seventh module 314 can communicate with the sixth module 312 to make ratings of vending locations available to brands as they decide whether to contract with a vending location. Similarly, the seventh module 314 can obtain sales data associated with branded drinks to provide the sales data to vending locations as they decide whether to work with a brand. As a result, the seventh module 314 can help increase transparency between brands and vending locations, increase quality control for branded beverages, and/or the like.

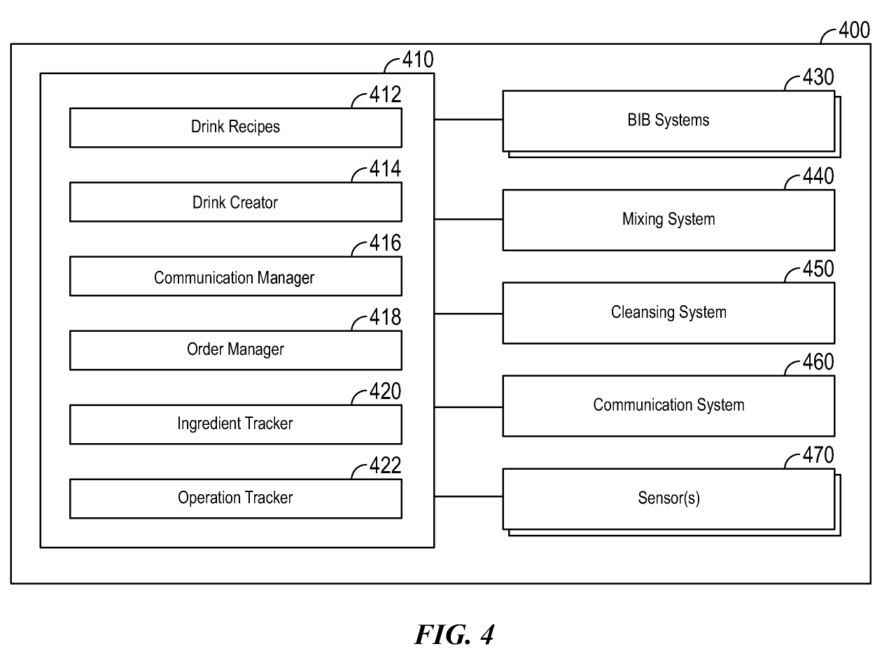

FIG. 4 is a block diagram of a subsystem 400 for a beverage robot in accordance with some embodiments of the present technology. The subsystem 400 can be deployed, for example, in the food/beverage robots 222 discussed above with respect to the environment 200 of FIG. 2. A processor and/or a storage component are not illustrated in FIG. 4 to avoid obscuring the illustrated components of the subsystem 400. However, one of skill in the art will understand that the subsystem 400 can include one or more processors and any suitable number of storage components to facilitate various operations of the subsystem 400 described herein.

As illustrated in FIG. 4, the subsystem 400 includes an operating platform 410 (“platform 410”) with one or more modules (six shown, referred to individually as first–sixth modules 412–422), as well as one or more BIB systems 430 (and/or other suitable ingredient containers), a mixing system 440, a cleansing system 450, a communication system 460, and one or more sensors 470.

The BIB systems 430 can store various concentrated ingredients related to beverage offerings from the subsystem 400. The mixing system 440 can receive and mix ingredients from the BIB systems 430 according to a recipe in a relatively short time (e.g., in less than a minute per beverage, less than 40 seconds per beverage, less than 30 seconds per beverage, and/or the like). In various embodiments, the mixing system 440 can include a blending component, shaking component, stirring component, emulsifying component, and/or any other suitable system to mix the ingredients according to the recipe. The cleansing system 450 can clean the mixing system 440, and/or any tubing and/or valves between the BIB systems 430 and the mixing system 440. The cleansing system 450 can be configured to operate between each beverage to avoid flavor contamination between beverages. Additionally, or alternatively, the cleansing system 450 can operate periodically to kill bacteria and/or build up in the tubing and/or valves.

The communication system 460 can operably couple the subsystem 400 to various other subsystems and/or platforms, such as other beverage robots, the POS system 224 of FIG. 2, and/or the platform 300 of FIG. 3. In various embodiments, the communication system 460 can include components configured to communicate over a shortrange wireless standard (e.g., a Bluetooth®, Zigbee®, Z-Wave®, Wi-Fi HaLow®, or any other suitable shortrange standard), communicate with a network over a wireless (or wired) internet connection (e.g., a WiFi connection or ethernet connection), and/or communicate with the network through a cellular internet connection (e.g., based on a 3G, 4G, LTE, 5G, 6G, or other standard).

The sensors 470 can be coupled to various components of the subsystem 400 to help monitor the operation of the beverage robot. For example, the sensors can include weight and/or volume sensors coupled to the BIB systems 430 to measure remaining ingredients in each BIB; temperature sensors in the BIB systems 430 to help monitor a freshness and/or status of ingredients; volumetric dispensing sensors to monitor the volume of ingredients provided to the mixing system 440; operating sensors coupled to the cleansing system 450 to monitor a frequency of cleansing; and/or the like. Additionally, or alternatively, the sensors 470 can include sensors that monitor connections between the BIB systems 430 and the mixing system 440 to make sure tubes, valves, and/or nozzles are properly connected and in good health; and/or other sensors to monitor a health condition of the beverage robot.

The platform 410 can be operably coupled to each of the BIB systems 430, the mixing system 440, the cleansing system 450, the communication system 460, and/or the sensors 470 to facilitate various operations of the beverage robot via the first–sixth modules 412–422 (and/or any other suitable modules). For example, the first module 412 can store drink recipes specific to the beverage robot, access the drink recipe library in the first module 302 of FIG. 3, and share drink recipes with other beverage robots (e.g., to allow the other beverage robots to prepare the recipe) and/or receive recipes from other beverage robots. Further, the first module 412 can communicate with a POS system and/or other user interface to share information on the beverages available in the subsystem 400.

The second module 414 includes a drink creator. The drink creator can allow a vending location to customize a drink recipe from the first module 412 (e.g., adjusting the portions of ingredients, adding or removing ingredients, changing an order the ingredients are added/mixed, and/or the like). Accordingly, the drink creator can allow the vending location to customize generic recipes to preferences of the vending location. Additionally, or alternatively, the drink creator in the second module 44 can communicate with a POS system and/or other user interface to allow a user (e.g., a customer) to customize a beverage to their preferences (e.g., to change milk types, remove an ingredient, add an ingredient, and/or the like).

The third module 416 can include a communication manager. The communication manager can work with any of the modules in the platform 410 and/or any of the other components of the subsystem 400 to communicate outside of the subsystem 400. In a specific, non-limiting example, the communication manager can help direct communications between the first module 412 and a drink library in the remote system 210 of FIG. 2 to move drink recipes therebetween. In another specific, non-limiting example, the communication manager can send data from the sensors 470 to the robot operating rating system in the sixth module 312 discussed above with reference to FIG. 3.

The fourth module 418 can include an order manager. Similar to the order manager discussed above with reference to FIG. 3, the order manager can queue orders (or individual beverages from orders) to be produced by the beverage robot associated with the subsystem 400 and/or various other beverage robots in communication with the subsystem 400. For example, the order manager can queue orders at beverage robots with shorter wait times and the necessary ingredients. Additionally, or alternatively, the order manager can queue orders to sync estimated completion times with estimated pick-up times. In another example, the order manager can track the status of an order throughout the production process (e.g., by monitoring the position in the queue(s)) to provide customers with a real-time, accurate prediction of when their order will be complete. The increased transparency can increase customer satisfaction, particularly during busy times at a vending location. In yet another example, the order manager can receive order changes after an order is queued, modify the order in the queue, then produce the order. The on-site accessibility of the order manager can increase a speed of the order management and/or allow a vending location to override order queuing directly from the subsystem 400.

The fifth module 420 can include an ingredient tracker. Similar to the ingredient manager discussed above with reference to FIG. 3, the ingredient tracker can help monitor a volume of ingredients remaining in each of the BIB systems 430, track an age of the ingredients in the BIB systems 430, and/or the like. As a result, the ingredient tracker can notify a vending location when one of the BIB systems 430 needs to be replaced or will need to be replaced soon. Additionally, or alternatively, the ingredient tracker can help monitor overall volumes of ingredients used during a relevant time period to identify popular (or unpopular ingredients). The information can be useful, for example, in managing the vending location’s inventory and orders related to various ingredients. Still further, the ingredient tracker can help identify ingredients approaching their expiration date, prompt the vending location to change the ingredients, and/or prevent the subsystem 400 from vending expired ingredients.

The sixth module 422 can include an operation tracker. The operation tracker can be communicably coupled to the order manager in the fourth module 418, the BIB systems 430, the mixing system 440, the sensors 470, and/or any other suitable components of the subsystem 400 to record operations thereof. As a result, the operation tracker can help track drink sales, identify cleaning and/or maintenance patterns, ensure the BIB systems 430 are properly installed, track how often the BIB systems 430 are swapped, whether correct BIB systems 430 are swapped, whether the mixing system 440 is properly cleaned between orders, and/or the like. The information can be used by the vending location to help improve sales, identify popular (or unpopular) beverages, improve quality control, monitor staff operations, and/or the like. Additionally, or alternatively, the information can be used to schedule (or predict) maintenance for the beverage robot. Additionally, or alternatively, the information can be shared with an external system, such as the service dashboard and/or robot operating rating systems discussed above with reference to FIG. 3.

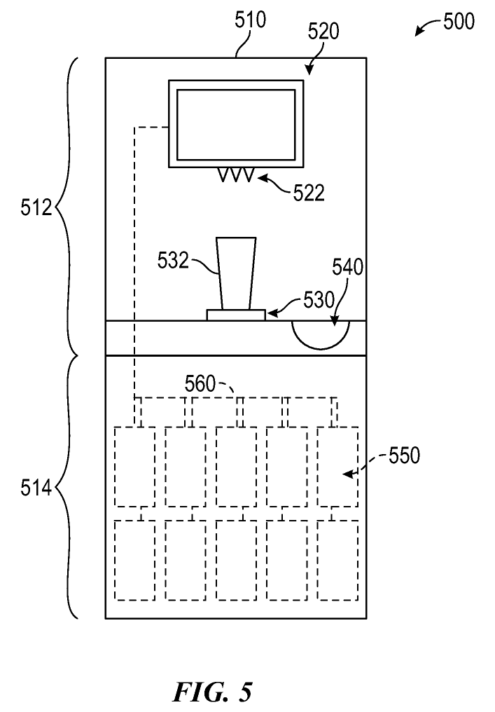

FIG. 5 is a schematic front view of a beverage robot 500 configured in accordance with some embodiments of the present technology. In the illustrated embodiment, the beverage robot 500 (sometimes also referred to herein as a “beverage production device”) includes a housing 510 having an upper portion 512 and a lower portion 514 fluidly coupled to the upper portion 512. The upper portion 512 (sometimes also referred to as a “mixing portion,” an “active blending portion,” and/or the like) can include a dispensing head 520 positioned above a mixing driver 530 and a mixing container 532. The dispensing head 520 can include one or more nozzles 522 (three shown in the illustrated embodiment) that are positioned to dispense ingredients (e.g., concentrated juices, coffee, tea, syrups, water, sparkling water, and/or the like) into the mixing container 532. The mixing driver 530 can include a blender, shaker, emulsifier, and/or any other suitable component. The mixing container 532 can include a detachable container, an open container (e.g., an open cup), a closable container, and/or any other suitable component. As further illustrated in FIG. 5, the upper portion 512 can also include a cleansing system 540 adjacent to the mixing driver 530. The cleansing system 540 can include a glass rinser/washer that is configured to dispense water and/or a cleaning solution into the mixing container 532 and a draining component (e.g., a sink) to receive and carry used water and/or cleaning solution away from the mixing container 532. In some embodiments, the cleansing system 540 includes an automatic scrubber positioned to scrub the mixing container over the draining component.

During operation, the beverage robot 500 can dispense one or more ingredients through the dispensing head 520 and into the mixing container 532. The beverage robot 500 can then operate the mixing driver 530 to mix, blend, emulsify, and/or otherwise combine the ingredients in the mixing container 532. The beverage robot 500 can then repeat the process to dispense one or more additional ingredients and combine ingredients in the mixing container 532 according to a recipe for a current beverage. Additionally, or alternatively, the beverage robot 500 can dispense one or more ingredients to top the current beverage. A user of the beverage robot 500 (e.g., staff at a restaurant) can then pour the beverage out of the mixing container 532 into a container for the customer (e.g., a cup, disposable cup, bottle, carafe, bowl, and/or any other suitable container). Once empty, the user can position the mixing container 532 over the cleansing system 540 and operate the cleansing system 540 to clean and/or sanitize the mixing container 532. The user can then reset the mixing container 532 on the mixing driver 530 to prepare the beverage robot 500 for the next beverage.

As illustrated in FIG. 5, the lower portion (sometimes referred to as a “storage portion,” a “refrigeration portion,” and/or the like) can store one or more ingredient packages 550 (e.g., the BIB systems 430 discussed above with reference to FIG. 4). Each of the ingredient packages 550 can contain a concentrated ingredient that is used in one or more recipes that the beverage robot 500 can prepare. The ingredient packages 550 can be independently accessible and/or replaceable, allowing the user to swap packages as supply in any of the ingredient packages 550 runs low. In some embodiments, the lower portion 514 is refrigerated to keep the ingredient packages 550 at or below a predetermined temperature. In some embodiments, the lower portion 514 includes one or more sub-portions. A first sub-portion can be refrigerated to preserve perishable ingredients while a second sub-portion is not refrigerated (or heated) and stores non-perishable ingredients. The second sub-portion can be useful, for example, to store ingredients that become too viscous to adequately dispense when cooled.

As further illustrated in FIG. 5, each of the ingredient packages 550 can be fluidly coupled to the dispensing head 520 through vending lines 560. The vending lines 560 can include various components (e.g., valves, tubing connections, pumps, volumetric meters, pre-mixing components, and/or the like) to quickly provide ingredients to the dispensing head 520 with accurate volumetric amounts. In some embodiments, the vending lines 560 include a cleansing system configured to clean one or more of the tubing connections between beverages to reduce (or eliminate) cross-contamination. Further, in various embodiments, the lower portion 514 can be positioned directly beneath the upper portion 512 and/or can be separated from and fluidly coupled to the upper portion 512. In embodiments where the lower portion 514 is separated from the upper portion 512, the beverage robot 500 can include longer vending lines 560 and/or additional compression components to move ingredients between the lower portion 514 and the dispensing head 520.

### III.Embodiments of a Beverage Matching System

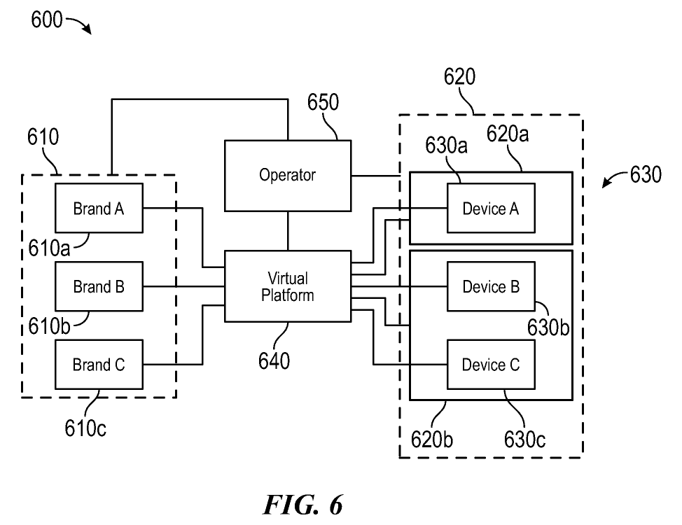

FIG. 6 is a schematic block diagram illustrating a beverage matching system 600 (“the system 600”) configured in accordance with embodiments of the present technology. The system 600 can include a plurality of beverage brands 610 (three illustrated in FIG. 6, referred to individually as a “first brand 610a,” a “second brand 610b,” and a “third brand 610c”; also referred to herein as “recipe generators”), a plurality of stores 620 (two illustrated in FIG. 6, referred to individually as a “first store 620a” and a “second store 620b”; also referred to herein as “beverage-generating locations”), a plurality of beverage production devices (three illustrated in FIG. 6, referred to individually as a “first device 630a,” a “second device 630b,” and a “third device 630c;” collectively referred to as “the devices 630”), a virtual platform 640, and an operator 650 of the virtual platform 640. As discussed further herein, the virtual platform 640 can match one or more of the brands 610 with one or more of the stores 620, which can then sell beverages made according to recipes from the brands 610 to consumers.

The beverage brands 610 can include people, companies, and/or other entities that create recipes for making beverages. Example beverages include juice, coffee, tea, soda, alcoholic drinks, bubble tea, mocktails, dairy-based drinks and non-dairy alternatives, etc. Recipes can specify quantities and proportions of ingredients, an order in which the ingredients should be dispensed, pressure and flow rate settings for the devices 630 for each ingredient, etc. Recipes may also include cup decoration patterns for decorating, for example, the inner surface of cups prior to (and/or after) dispensing the ingredients into the cup to make the beverage. Further, the brands 610 can be associated with the flavor profile and/or qualities of their beverages. As a result, consumers (e.g., the customers 10 of FIG. 1) have various taste and/or quality-related expectations when they order a beverage associated with one of the brands 610 and/or will attribute the taste and/or quality of the beverage to the brands 610.

The stores 620 can be examples of the vending location 120 (FIG. 1) and/or the vending locations 220 (FIG. 2), and can include cafés, restaurants, bars, retailers, wholesale vendors, convenience stores, food court vendors, specialty stores, vending machines, and/or other vendors that sell beverages to consumers. The devices 630 can be examples of the food/beverage robots 222 (FIG. 2) and/or the beverage robot 500 (FIG. 5), and can produce beverages on-site and in real-time according to known recipes. Each store 620 can include one or more devices 630. In FIG. 6, for example, the first store 620a includes the first device 630a, and the second store 620b includes the second device 630b and the third device 630c. In various other examples, the first store 620a can include two, three, five, and/or any other suitable numbers of the devices 630. Additionally, or alternatively, the second store 620b can include one, three, five and/or any other suitable numbers of the devices 630. The number of devices 630 in any of the stores 620 can depend on, for example, typical or anticipated consumer traffic in that particular store 620, a range of beverages the particular store 620 wants to offer, a number of ingredients stored in each of the devices 630, and/or the like.

The virtual platform 640 can be implemented on or as part of the remote system 110 (FIG. 1) and/or the remote system 210 (FIG. 2), and can implement the platform 300 (FIG. 3). As shown in FIG. 6, the virtual platform 640 can communicate with each of the beverage brands 610, each of the stores 620, each of the devices 630, and the operator 650. In some embodiments, for stores 620 with multiple devices 630, the virtual platform only or primarily communicates with one of the multiple devices 630. The operator 650 can manage operation of the virtual platform 640. Additionally, or alternatively, the operator 650 can communicate with the beverage brands 610 and the stores 620, as discussed further herein.

In operation, the virtual platform 640 receives brand operation details from each of the beverage brands 610. The brand operation details can include ingredient management details, beverage production details, and marketing guidelines. The ingredient management details can include supplier information, ingredient information (e.g., costs, shelf life, cleaning frequency, pH level, sweetness levels (e.g., in comparison to sucrose solutions), water activity, proportions, etc. associated with individual ingredients), and end product information (e.g., size, weight, suggested retail price, etc. of the produced beverage). If one or more pieces of information is missing (e.g., storage conditions for certain ingredients), the virtual platform 640 can supplement the ingredient management details by requesting additional information from the beverage brands 610 and/or the operator 650, and/or by generating additional information on its own. The virtual platform 640 can communicate the received ingredient management details to the operator 650, and the operator 650 can then work with suppliers to receive and format the ingredients as needed for desired quality and flavor. For example, the operator 650 can test the ingredients for compatibility with the devices 630, develop ingredient dispense accuracy curves, and adapt the ingredients accordingly. The operator 650 can also store the ingredients received from the suppliers and deliver the ingredients to the stores 620 to fulfill orders as needed.

The beverage production details can include recipes specifying the order and quantity of ingredients to be dispensed. An algorithm of the virtual platform 640 can translate and/or adapt the beverage production details for use by the devices 630. For example, the algorithm of the virtual platform 640 can specify the dispensing flow rate and pressure of particular ingredients for use by the devices 630. Additionally, or alternatively, an algorithm of the virtual platform 640 can adapt certain instructions for operating the devices 630 for store staff, delegate one or more portions of the recipe to the devices 630 and delegate one or more portions of the recipe to store staff, and/or the like. The instructions can be displayed on a user interface (UI) on the device 630 or on a different device (e.g., computer). For example, the UI can display an instruction to a staff member to sprinkle matcha powder on top of the drink produced by the device 630 as a final production step.

The marketing guidelines can include marketing material templates, design guidelines, and in-store requirements that guide stores 620 on how to present the brands 610 they are serving. For example, the marketing material templates can serve as a starting point for creating marketing materials that align with the brand’s identity and messaging. The templates can be general or specific to Point of Purchase (POP) displays, table tents, posters, menu designs, etc. The design guidelines can specify Pantone color numbers, font choices, sizes, logo usage, and other visual elements to be used in marketing materials. The design guidelines can help ensure that all marketing materials associated with the brand 610 maintain a cohesive look and feel across different channels and touchpoints. The in-store requirements can specify how to set up marketing materials in-store (e.g., ideal locations for setting up POP displays, posters, menu boards, and other promotional materials) to maximize visibility and impact. The virtual platform 640 can then communicate the brand’s marketing guidelines to the stores 620 and/or enforce the brand’s marketing guidelines at each of the stores 620 that carry beverages from the brand. By adhering to the brand’s marketing guidelines, the stores 620 (and the virtual platform 640) help ensure that promotional efforts are consistent with the overall image and messaging of the brands 610 they are serving, enhancing brand recognition and customer engagement.

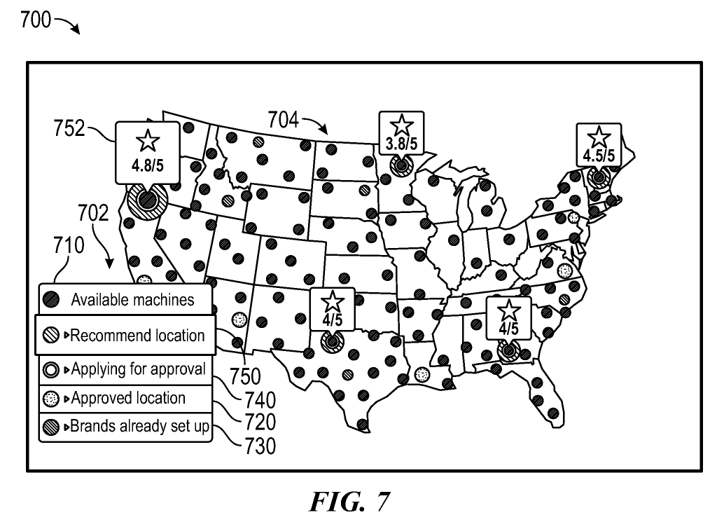

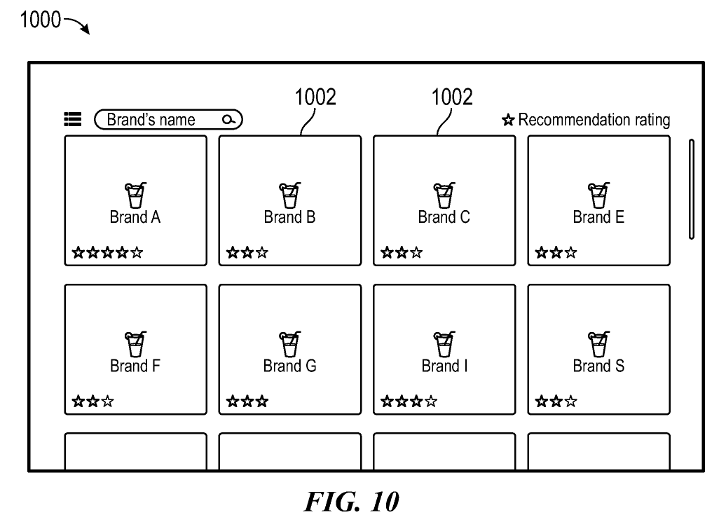

As discussed further herein, the virtual platform 640 can facilitate a matching process between one or more of the brands 610 and one or more of the stores 620. Once a match is made, the stores 620 can download the ingredient management details, the beverage production details, the marketing guidelines, and other guidelines from the matched brand 610 from the virtual platform 640 onto devices 630 in the store 620 and/or other devices (e.g., computers, mobile phones). As also discussed further herein, the matching process can be initiated by one of the brands 610, by one of the stores 620, by the virtual platform 640, and/or any combination therein. FIGS. 7–9 illustrate a series of UIs from the perspective of one of the beverage brands 610 looking for a store to match with. FIGS. 10–13 illustrate a series of UIs from the perspective of one of the stores 620 looking for a brand to match with.

Referring first to FIG. 7, a UI 700 displays a legend 702 and a map 704 with graphical overlays. The UI 700 can be specific to a particular beverage brand looking to match with a store. The map 704 can be of any suitable region, such as the continental United States illustrated in FIG. 7, any other county, a continent, a state or province of any suitable country, multiple states and/or provinces within a region, a county, city, and/or the like. As indicated by the legend 702, the graphical overlays can include first markers 710 indicative of stores (e.g., the stores 620) or machines (e.g., the devices 630) that are available for applying to, second markers 720 indicative of stores that have already approved the brand, and third markers 730 indicative of stores that are already selling the brand’s beverages. In some embodiments, the first markers 710 represent each and every store and/or machine registered with the virtual platform (e.g., the virtual platform 640) and within the region displayed on the map 704. A single first marker 710 may represent a group of stores and/or machines to avoid clutter on the UI 700.

In some embodiments, the first markers 710 represent a subset of the stores and/or machines registered with the virtual platform. For example, an algorithm of the virtual platform can filter its list of registered stores and/or machines based on which stores and/or machines have the ability, capacity, and/or compatibility to handle the brand’s beverages, and display, on the UI 700 using the first markers 710, only stores and/or machines that have not been filtered out. In some embodiments, the filtering or identification of select stores is based at least in part on metadata associated with each of the stores. The metadata can include a category of the store (e.g., cafes, coffee shops, bars, restaurants, theaters, and/or the like), categories of the beverages sold (e.g., coffee, tea, boba, alcoholic beverages, specialty drinks, and/or the like), hours of operation (e.g., morning, evening, nighttime), geographical location (e.g., downtown, suburbs), demographic information around the store, age restrictions (e.g., 21 and over), liquor licenses held, and/or any subset thereof and/or any other suitable information. The algorithm can use information about the brand and the metadata to help identify and/or filter through the stores. For example, if the brand primarily sells alcoholic beverages, the algorithm of the virtual platform may filter out cafes that are open only during morning hours. As another example, the algorithm of the virtual platform can filter out stores that do not have ingredients required to make one or more of the brand’s beverages (and/or stores that cannot/will not obtain or store that ingredient due to supply chain issues, excessive shipping costs, lack of a proper storage system and/or space, existing relationships requiring certain ingredients, and/or the like).

The UI 700 can also display fourth markers 740 indicative of stores currently reviewing the brand’s application, and fifth markers 750 indicative of stores that the virtual platform 640 recommends that the brand apply to. In some embodiments, the fourth markers 740 and/or the fifth markers 750 can be overlaid over one or more of the first markers 710. For example, in FIG. 7, the first markers 710 are illustrated as filled circles and the fifth markers 750 are illustrated as rings around select ones of the first markers 710. In some embodiments, the recommended stores (e.g., indicated by the fifth markers 750) are selected based at least in part on the ratings of the stores. The UI 700 can display such ratings 752 (e.g., 4.8 out of 5 stars) overlaid on the stores indicated by the fifth markers 750 as recommended to provide a high-level overview of stores that the brand may want to apply to. The brand can then select the stores they are interested in, such as by clicking on the markers associated with those stores.

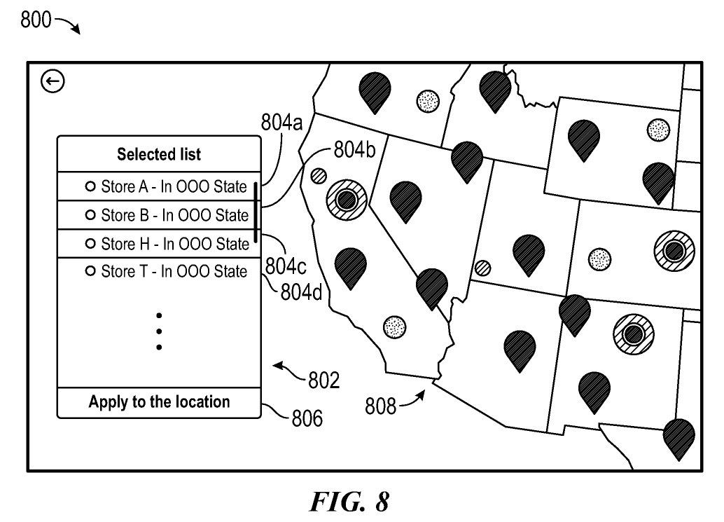

Referring next to FIG. 8, a UI 800 displays a list 802 of the selected stores on the left side and an enlarged map 808 on the right side. The map 808 can be sized (e.g., zoomed in) to display the selected stores, which can also be marked (e.g., with rings), as shown. The list 802 can display individual stores (e.g., first–fourth stores 804a–804d) and associated details, such as the states in which they are located, their name, etc. The brand can then select one or more of the first–fourth stores 804a–804d to apply to. For example, as illustrated in FIG. 8, the UI 800 can include a button 806 for submitting an application to the selected store (e.g., at the bottom of the list 802 and/or in any other suitable location).

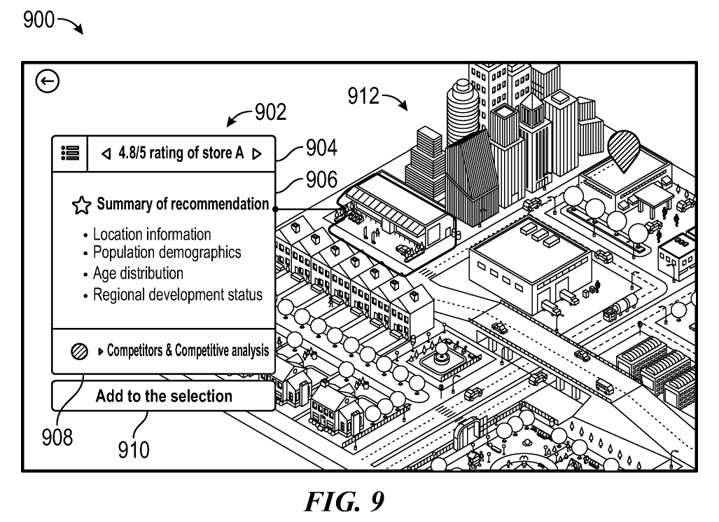

Referring next to FIG. 9, a UI 900 displays a panel 902 and a schematic, perspective visualization 912 of a neighborhood (and/or any other suitable region of a map). The panel 902 can include a header 904, a first subpanel 906, a second subpanel 908, and a selection button 910. The header 904 can display the rating and name of store selected within the visualization 912. The first subpanel 906 can display additional details associated with the selected store, such as location information, population demographics, age distribution, regional development status, etc. The second subpanel 908 can display information associated with a competitor store, including competitive analysis. As shown, the visualization 912 illustrates the relative locations of the selected store and the competitor, as well as illustrations of neighboring buildings and streets. The selection button 910 can allow the brand to add the selected store to, for example, a list of stores to apply to.

The map and neighborhood views illustrated in FIGS. 7–9 provide visualizations of the stores’ available locations and can also highlight locations suitable for selling the brand’s beverages, as deemed by the algorithm of the virtual platform (e.g., the virtual platform 640 FIG. 6). For example, the virtual platform 640 of FIG. 6 can aggregate statistics associated with the brand seeking locations and stores on the virtual platform 640, and generate recommendations for the brand. The recommendations can be based on foot traffic, demographics, market demand, ratings, location information, potential profitability, alignment with brand strategies, and/or other criteria. Once the virtual platform receives an input from the brand indicating which store they would like to apply to, the virtual platform can present an application form for the brand to fill out. Once the brand completes the application, the virtual platform can submit the completed application to the store. The application can include terms and conditions, operational details and requirements, a profit-sharing model outlining the proposed partnership, etc. In some embodiments, the virtual platform can suggest the terms and conditions, operational details and requirements, profit-sharing model and/or the like for the potential partnership (e.g., standard terms and conditions from the virtual platform, customized terms and conditions generated by the virtual platform for the store and brand, and/or the like). Once the virtual platform submits the application to the store, the store can then accept or reject the brand’s application and/or propose modifications to the terms and conditions and/or other partnership parameters in the application. If the application is accepted, the virtual platform can initiate coordination steps to launch the brand at the matched store.

FIG. 10 illustrates a UI 1000 presented to a store looking for brands to match with. As shown, the UI 1000 displays a plurality of panels 1002, each representing a brand. Each panel 1002 can display the name of the brand, an associated image, and/or a rating of the brand (e.g., an average rating by customers, a recommendation rating calculated by the virtual platform 640 (FIG. 6), the operator 650, and/or the like). The store can select one of the panels 1002 to view additional details regarding any of the brands.

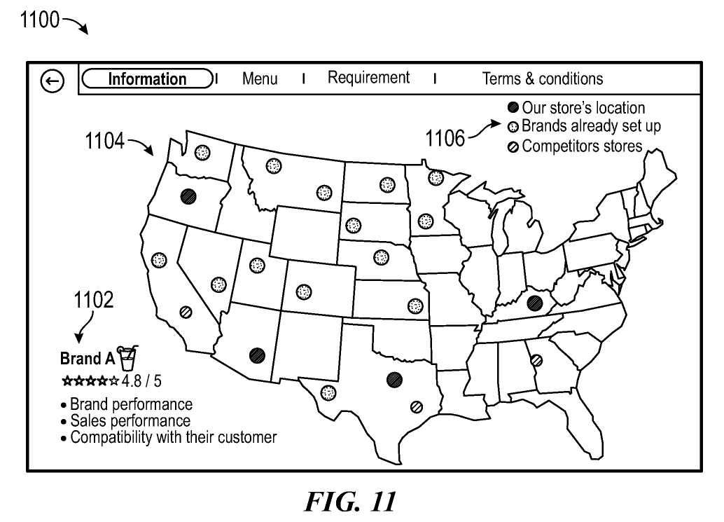

FIG. 11 illustrates a UI 1100 displaying a panel 1102, a map 1104, and a legend 1106 for the map 1104. The panel 1102 can display information regarding a selected brand, including the name, the rating, brand performance, sales performance, compatibility with customers of the store (e.g., as calculated by the virtual platform 640 (FIG. 6) using demographic and/or other information related to the store), etc. As indicated in the legend 1106, the map 1104 can display the store’s own locations that are available to sell the selected brand, the store’s own locations that are already selling the selected brand, and competitors’ stores selling the selected brand. Therefore, the UI 1100 can provide a quick overview of the selected brand, how sale of the brand’s beverages may be expanded to new locations of the store, and/or where the store will have competition selling the brand’s beverages.

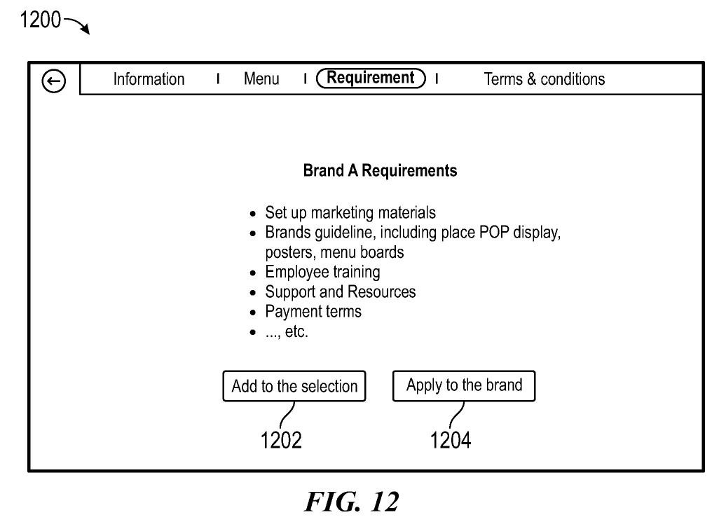

FIG. 12 illustrates a UI 1200 displaying requirements for selling a selected brand’s beverages (e.g., as provided by the selected brand). The requirements can include one or more conditions that the store must currently meet and/or must fulfill once they are matched. For example, requirements can relate to how marketing materials should be set up and/or displayed, guidelines for placing POP displays, posters, menu boards, etc., employee training, support and resources, payment terms, etc. The UI 1200 can also include a first button 1202 allowing the store to add the selected brand to a list (e.g., a list of brands to apply to) and/or a second button 1204 allowing the store to directly apply to the selected brand.

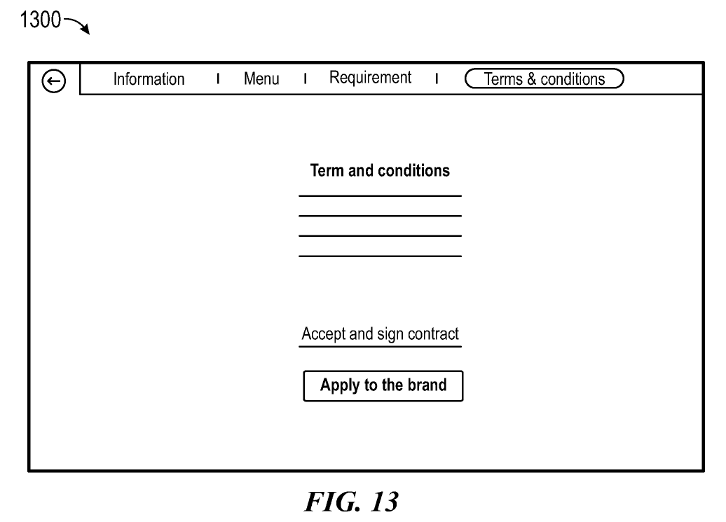

FIG. 13 illustrates a UI 1300 displaying an application form for the store to fill out to apply for the brand. The application form can include, for example, terms and conditions of the potential partnership. In some embodiments, the UI 1300 can suggest the terms and conditions for the potential partnership (e.g., standard terms and conditions from the virtual platform 640 (FIG. 6), customized terms and conditions generated by the virtual platform 640 for the store and brand, and/or the like). The UI 1300 can also provide a signature block and a button for the store to submit the application.

Once a match is made, the virtual platform (e.g., the virtual platform 640 of FIG. 6) can facilitate additional procedures for launching the brand at the matched store. For example, the virtual platform can present, to the store, a certification program provided by the brand and for staff members of the store to pass. The certification program can be designed to ensure that staff members are trained and knowledgeable about the brand’s beverage offerings, preparation processes, and quality standards. Additionally, or alternatively, the virtual platform can provide the recipe information to the beverage production device(s) (e.g., the devices 630 of FIG. 6) at the store to enable the beverage production device(s) to precisely prepare branded beverages. Additionally, or alternatively, the virtual platform can coordinate a launching event to promote the brand’s arrival at the store and generate interest in the local community.

Once the brand has launched at the store, the devices 630 in the store can produce the brand’s beverages according to the recipe provided by the brand. The store can submit orders for ingredients and consumables for producing the brand’s beverages through the virtual platform 640. In some embodiments, the virtual platform 640 can automatically place such orders based on current inventory in the store. In some embodiments, the virtual platform 640 can update the beverage production devices (e.g., the devices 630) with new menu items and ingredients provided by the brand.

By fostering a dynamic ecosystem in which brands and stores collaborate strategically, the virtual platform 640 described herein is expected to benefit brands, stores, and consumers. For brands, the virtual platform 640 can (i) simplify the new store launch process by leveraging streamlined operations and automated tools, (ii) help brands expand rapidly to desired locations with integrated map views and recommendations for ideal locations, (iii) maintain strict control over beverage quality through standardized processes and the beverage production precision of the devices 630, (iv) increase brand awareness nationwide by consistently delivering high-quality beverages and engaging marketing materials, and (v) boost beverage revenue by leveraging data-driven insights for strategic decision-making and optimizing operations.

For stores, the virtual platform 640 can (i) leverage the brand’s reputation to attract more consumers and increase foot traffic, (ii) enhance beverage revenue by offering high-quality branded beverages that meet customer expectations, (iii) utilize marketing resources and support to promote the brand’s arrival and generate interest in the local community, (iv) provide exceptional customer service and experiences to build loyalty and encourage continued business, and (v) allow the stores to prepare the branded beverages with a consistent flavor profile and/or quality to meet customer expectations when ordering the branded beverages.

For consumers, the virtual platform 640 can (i) meet changing consumer demands for different beverages by introducing popular beverages at local stores rapidly, and (ii) introduce consumers to new brands expected to be popular based on demographics and other information.

The virtual platform 640 can also benefit brands, stores, and consumers by ensuring consistency (e.g., quality consistency) in the produced branded beverages across different store locations and over time. For example, as discussed herein, the virtual platform 640 can communicate and/or confirm compliance to operational instructions that specify where ingredients should be sourced from, when beverage robots need to be refilled with ingredients, ingredient storing conditions, exact recipes for the beverages (e.g., ratios of ingredients, volumes of the ingredients; exact orders and instructions for adding, mixing, blending, layering, and/or otherwise combining the ingredients; and/or the like), how often the beverage robots need to undergo cleaning or maintenance, and/or the like. Ensuring consistency in the produced branded beverages allows the virtual platform 640 to match brands with stores irrespective of geographical location, language barriers, workforce turnover, etc. and to share recipes from brands across different stores. For example, without specific operational instructions, different stores may produce beverages of varying quality and/or flavor even if the same recipe is used. Additionally, or alternatively, the consistency in the produced branded beverages can increase consumer satisfaction by allowing stores to better meet consumer expectations when ordering branded beverages.

### IV.Embodiments of a Beverage Bidding System

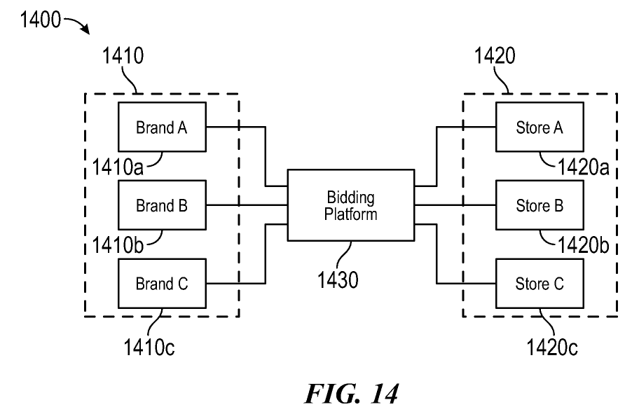

FIG. 14 is a schematic block diagram illustrating a beverage bidding system 1400 configured in accordance with embodiments of the present technology. The virtual platform 640 described above with reference to FIG. 6 provides an ecosystem in which brands and stores are matched based on mutual agreement. Because there are limits to how many brands a store can service and/or how many stores a brand is willing to put its name on, the ecosystem can have a scarcity in high-performance and/or highly-desired brands and/or stores. The beverage bidding system 1400 described herein can increase the quality and competitiveness of partnerships formed on the virtual platform 640 (FIG. 6) and/or increase transparency in the formation of the partnerships.

The beverage bidding system 1400 can include a plurality of brands 1410 (individually labeled 1410a, 1410b, 1410c), a plurality of stores 1420 (individually labeled 1420a, 1420b, 1420c), and a bidding platform 1430. The bidding platform 1430 can be implemented as part of the virtual platform 640 described above with reference to FIG. 6, and/or implemented separately on the remote system 110 (FIG. 1) and/or the remote system 210 (FIG. 2) and/or by the platform 300 (FIG. 3). The bidding platform 1430 can receive (i) bids from brands competing for high-performance stores (e.g., stores with high operational quality and/or foot traffic) and (ii) bids from stores competing for high-performance brands (e.g., popular and/or trending beverages). The bids can be based on cost, quality, volume, statistics of the bidder, etc.

The bidding platform 1430 can incentivize both brands and stores to improve their offerings and operational excellence to stand out in the marketplace. For example, brands can be motivated to provide high-quality products and support to attract bids from high-performance stores, leading to enhanced brand reputation and customer satisfaction. Similarly, stores can be motivated to optimize their operations, customer service, and foot traffic to attract bids from high-performance brands, driving improvements in store performance. Additionally, or alternatively, the bidding platform 1430 can ensure transparency and fairness in the bidding process by providing detailed metrics and criteria for evaluating bids. In some embodiments, the bidding platform publishes information related to the bids (e.g., which stores and/or brands receive a bid, which stores and/or brands submit a bid, which stores and/or brands win their bids, parameters related to the bids, and/or the like) to help increase transparency. Additionally, or alternatively, the bidding platform 1430 can facilitate communication and negotiations between brands and stores to establish mutually beneficial partnerships. Therefore, over time, the bidding platform 1430 is expected to encourage continuous improvement and innovation within the ecosystem provided by the virtual platform 640, raising the overall quality of service and customer experience.

### V.Methods for Matching Beverage Brands with Beverage Vendors

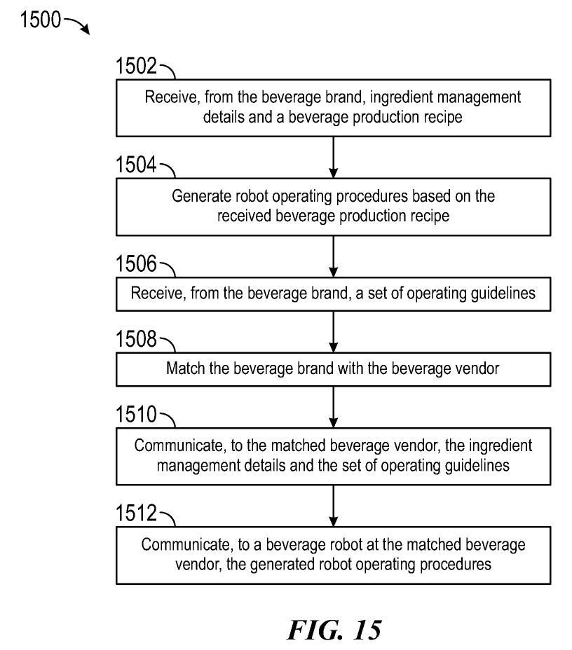

FIG. 15 is a flow diagram illustrating a method 1500 for matching beverage brands with beverage vendors. The method 1500 can be performed by the remote system 110 (FIG. 1), the remote system 210 (FIG. 2), the platform 300 (FIG. 3), the virtual platform 640 (FIG. 6), the bidding platform 1430 (FIG. 14), and/or other generally similar systems. Additionally, or alternatively, although discussed herein in the context of being executed entirely by a single component (e.g., entirely by the virtual platform 640), it will be understood that one or more steps in the method 1500 can be executed by a different computing device than one or more other steps.

The method 1500 can begin at block 1502 by receiving, from a beverage brand, ingredient management details and a beverage production recipe for one or more branded beverages. The ingredient management details can include supplier information, ingredient information, and end product information. The supplier information can include a list of suppliers providing ingredients for producing the beverage according to the received beverage production recipe. The ingredient information can include at least one of cost, shelf life, cleaning frequency, pH level, sweetness level, water activity, or proportions associated with ingredients for producing a beverage according to the received beverage production recipe. The end product information can include at least one of serving size, weight, or suggested retail price associated with the beverage to be produced according to the received beverage production recipe. The beverage production recipe can specify steps for producing the beverage, such as an order for combining ingredients, processes for combining ingredients (e.g., combination actions such as blending, shaking, stirring, and/or the like; times associated with the combination actions; and/or the like), processes for removing ingredients (e.g., straining ice from a beverage), an order for the processes, toppings, etc. for each of the branded beverage(s).

At block 1504, the method 1500 includes generating robot operating procedures based on the received beverage production recipe for each of the branded beverage(s). The robot operating procedures can comprise operating instructions for a beverage robot to produce one of the branded beverage(s) according to the received beverage production recipe for the branded beverage. For example, the robot operating procedures can specify the flow rate and/or pressure at which certain ingredients should be dispensed by the beverage robot. In another example, the robot operating procedures can specify actions to combine the ingredients (e.g., blending, shaking, stirring, and/or the like). The robot operating procedures can help improve a consistency in taste profiles and/or quality in the beverages prepared according to the beverage production recipe. For example, the robot operating procedures can help ensure consistent proportions of ingredients, a consistent and/or complete combination of the ingredients, intended diffusion of ingredients, a consistent temperature profile, etc.

At block 1506, the method 1500 includes receiving, from the beverage brand, a set of operating guidelines. The set of operating guidelines can include marketing guidelines specifying how marketing materials should appear and where the marketing materials should be positioned. For example, the operating guidelines can require specific fonts, colors, sizes, images, etc. In some embodiments, templates for marketing material are also received from the beverage brand. The operating guidelines can be applicable to each of the branded beverage(s) and/or specific to a subset of the branded beverage(s). In some embodiments, the method 1500 receives operating guidelines specific to each of the branded beverage(s) individually.

At block 1508, the method 1500 includes matching the beverage brand with the beverage vendor. In some embodiments, as discussed above, the matching is initiated by the beverage brand. For example, the method 1500 at block 1508 can include (i) displaying, on a user interface of the beverage brand, geographic information (e.g., a geographic map) and a plurality of markers on the geographic map, wherein each marker represents one of a plurality of beverage vendors. Displaying the geographic map and the markers can include (a) determining a match recommendation rating for each of the plurality of beverage vendors, (b) identifying one or more of the beverage vendors based on the match recommendation ratings of the beverage vendors, and (c) displaying, on the user interface and over the geographic map, one or more of the match recommendation ratings corresponding to the identified one or more beverage vendors. The markers can include (1) a first set of markers indicative of beverage vendors from which the beverage brand is awaiting approval, (2) a second set of markers indicative of beverage vendors that have approved the beverage brand, and/or (3) a third set of markers indicative of beverage vendors that are not accepting applications. In some embodiments, the match recommendation ratings can be specific to a subset of the branded beverage(s) offered by the brand. Purely by way of example, the match recommendation ratings for a juice blend from the brand can be different from the match recommendation ratings for a caffeinated beverage from the brand.

The method 1500 at block 1508 can further include (ii) receiving, via the user interface, a selection of one or more of the plurality of markers, and (iii) displaying, on the user interface, a list of a subset of the plurality of beverage vendors corresponding to the selected one or more markers. Additionally, or alternatively, the method 1500 at block 1508 can include displaying, on the user interface, an enlarged geographic map simultaneously with the list of the subset of beverage vendors. The enlarged geographic map can be sized to display the selected one or more markers.

The method 1500 at block 1508 can further include (iv) receiving, via the user interface, a selection of one of the subset of beverage vendors included on the list, and (v) displaying, on the user interface, a local-level view of the selected beverage vendor. The method 1500 at block 1508 can further include displaying, on the user interface and over the local-level view, a competitor marker indicative of a competitor vendor located in proximity to the selected beverage vendor and/or a competitive analysis report corresponding to the competitor vendor. The method 1500 at block 1508 can further include (vi) receiving, from the beverage brand, an application to apply to the selected beverage vendor, and (vii) communicating, to the selected beverage vendor, the received application.

In some embodiments, as also discussed above, the matching is initiated by the beverage vendor. For example, the method 1500 at block 1508 can further include (i) displaying, on a user interface of the beverage vendor, a plurality of panels, wherein each panel includes a name and a match recommendation rating of one of a plurality of beverage brands. The markers can include (a) a first set of markers indicative of store locations owned by the beverage vendor and currently selling the selected beverage brand (and/or a specific subset of beverage(s) from the beverage brand), (b) a second set of markers indicative of store locations owned by the beverage vendor and not currently selling the selected beverage brand, and/or (c) a third set of markers indicative of store locations not owned by the beverage vendor and currently selling the selected beverage brand (and/or the subset of beverage(s) from the beverage brand).

The method 1500 at block 1508 can further include (ii) receiving, via the user interface, a selection of one of the panels, (iii) displaying, on the user interface, a geographic map and a plurality of markers on the geographic map, wherein each marker represents one of a plurality of store locations, (iv) displaying, on the user interface, the set of operating guidelines corresponding to the selected beverage brand, (v) receiving, from the beverage vendor, an application to apply to the selected beverage brand, and (vi) communicating, to the selected beverage brand, the received application.

In some embodiments, the method 1500 at block 1508 includes operating a bidding system or platform for beverage brands and beverage vendors to bid for high-performance vendors and brands, respectively. For example, the method 1500 at block 1508 can further include receiving, from a plurality of beverage brands, a plurality of bids for the beverage vendor, and communicating, to the beverage vendor, (i) the plurality of bids, (ii) metrics of the plurality of beverage brands, and/or (iii) criteria for evaluating the plurality of bids. In another example, the method 1500 can further include receiving, from a plurality of beverage vendors, a plurality of bids for the beverage brand, and communicating, to the beverage brand, (i) the plurality of bids, (ii) metrics of the plurality of beverage vendors, and (iii) criteria for evaluating the plurality of bids.

At block 1510, in response to a match between a beverage brand and a beverage vendor, the method 1500 includes communicating, to the matched beverage vendor, the ingredient management details and the set of operating guidelines. The match can be generated by the beverage brand accepting the application from the beverage vendor and/or the beverage vendor accepting the application from the beverage brand. In embodiments where the beverage brand and/or the beverage vendor do not accept the application, method 1500 can include sending a message to the applicant indicating the rejection along with any provided reasons for the rejection (e.g., that the terms are not agreeable, that the beverage brand/beverage location is not looking to expand, that the beverage brand/beverage vendor do not meet quality and/or training standards, etc.) In some such embodiments, the rejection is accompanied by a counter-application with varied terms (e.g., an adjustment to pricing, training requirements, and/or the like). In various embodiments, the ingredient management details and/or the set of operating guidelines can be communicated to a POP system, a computing system, and/or one or more beverage robots at the matched beverage vendor.

At block 1512, the method 1500 includes communicating the generated robot operating procedures to one or more beverage robots at the matched beverage vendor (and any other suitable system at the matched beverage vendor), for one or more of the branded beverages from the brand. The robot operating procedures can then be executed by the beverage robot(s) at the matched beverage vendor (e.g., the food/beverage robots 222 of FIG. 2, the subsystem 400 of FIG. 4, the beverage robot 500 of FIG. 5, the devices 630 of FIG. 6, and/or the like) to prepare the one or more of the branded beverages from the brand.

### VI.Examples

The present technology is illustrated, for example, according to various aspects described below as numbered examples (1, 2, 3, etc.) for convenience. These are provided as examples and do not limit the present technology. It is noted that any of the dependent examples may be combined in any combination, and placed into a respective independent example. The other examples can be presented in a similar manner.

1. A method for operating a network of production robots, the method comprising:

receiving, from a recipe generator, a preparation recipe associated with a beverage from the recipe generator, wherein the preparation recipe specifies steps for preparing the beverage at an individual beverage robot from the network of beverage robots;

generating robot operating procedures based on the received preparation recipe, wherein the robot operating procedures comprise operating instructions for the individual beverage robot to prepare the beverage according to the received preparation recipe;

identifying one or more beverage-generating locations available to prepare the beverage;

receiving, from the recipe generator, a selection of a beverage-generating location; and

communicating the generated robot operating procedures to at least one beverage robot at the selected beverage-generating location to allow the at least one beverage robot to prepare the beverage according to the preparation recipe.

2. The method of example 1, wherein receiving the selection of the beverage-generating location comprises:

displaying, on a user interface, a geographic information and a plurality of markers on the geographic information, wherein each marker represents one or more of the identified one or more beverage-generating locations;

receiving, via the user interface, a selection of one or more of the plurality of markers;

displaying, on the user interface, a list of a subset of the beverage-generating locations corresponding to the selected one or more markers;

receiving, via the user interface, a selection of one of the subset of the beverage-generating locations included on the list;

displaying, on the user interface, a local-level view of the selected one of the subset of the beverage-generating locations;

receiving, from the recipe generator, an application to apply to the selected one of the subset of the beverage-generating locations; and

communicating, to the selected one of the subset of the beverage-generating locations, the received application.

3. The method of example 2, wherein displaying the geographic information and the plurality of markers comprises:

determining a match recommendation rating for each of the identified one or more beverage-generating locations;

selecting one or more of the identified one or more beverage-generating locations based on the match recommendation ratings of the beverage-generating locations; and

displaying, on the user interface and over the geographic information, one or more of the match recommendation ratings corresponding to the selected one or more beverage-generating locations.

4. The method of any one of examples 1–3, wherein the plurality of markers comprises:

a first set of markers indicative of beverage-generating locations from which the recipe generator is awaiting approval;

a second set of markers indicative of beverage-generating locations that have approved the recipe generator; and

a third set of markers indicative of beverage-generating locations that are not accepting applications.

5. The method of any one of examples 1–4, further comprising:

displaying, on the user interface, an enlarged geographic information simultaneously with the list of the subset of the beverage-generating locations, wherein the enlarged geographic information is sized to display the selected one or more markers.

6. The method of any one of examples 1–5, wherein displaying the local-level view of the selected beverage-generating location comprises:

displaying, on the user interface and over the local-level view, (i) a competitor marker indicative of a competitor beverage-generating location located in proximity to the selected beverage-generating location and (ii) a competitive analysis report corresponding to the competitor beverage-generating location.

7. The method of any one of examples 1–6, further comprising:

receiving, from a plurality of recipe generators including the recipe generator, a plurality of bids for one of the beverage-generating locations; and

communicating, to the one of the beverage-generating locations, (i) the plurality of bids, (ii) metrics of the plurality of recipe generators, and (iii) criteria for evaluating the plurality of bids.

8. The method of any one of examples 1–7, further comprising:

receiving, from the one or more beverage-generating locations, a plurality of bids for the recipe generator; and

communicating, to the recipe generator, (i) the plurality of bids, (ii) metrics of the one or more beverage-generating locations, and (iii) criteria for evaluating the plurality of bids.

9. The method of any one of examples 1–8, further comprising:

receiving, from the recipe generator, supplier information including a list of suppliers providing ingredients for producing the beverage according to the received preparation recipe.

10. The method of any one of examples 1–9, further comprising:

receiving, from the recipe generator, ingredient information including at least one of cost, shelf life, cleaning frequency, pH level, water activity, or proportions associated with ingredients for producing the beverage according to the received preparation recipe.

11. The method of any one of examples 1–10, further comprising:

receiving, from the recipe generator, end product information including at least one of serving size, weight, or suggested retail price associated with the beverage to be produced according to the received preparation recipe.

12. The method of any one of examples 1–11, further comprising:

receiving, from the recipe generator, end product information including marketing guidelines specifying how marketing materials should appear and where the marketing materials should be positioned at the one or more beverage-generating locations.

13. The method of any one of examples 1–12, wherein identifying the one or more beverage-generating locations available to prepare the beverage is based at least in part on metadata associated with each of the one or more beverage-generating locations, wherein the metadata include at least one of a category of the beverage-generating location, categories of the beverages sold, hours of operation, geographical location, age restrictions, or liquor licenses held.

14. The method of any one of examples 1–13, wherein identifying the one or more beverage-generating locations available to prepare the beverage is based at least in part on ingredients available at individual beverage robots at each of the one or more beverage-generating locations.

15. A method for operating a network of production robots, the method comprising:

receiving, from a plurality of recipe generators, a plurality of preparation recipes each associated with a beverage from the recipe generators, wherein the preparation recipes each specifies steps for preparing the beverage at an individual beverage robot from the network of beverage robots;

generating robot operating procedures based on the received preparation recipe, wherein the robot operating procedures comprise operating instructions for the individual beverage robot to prepare the beverage according to the received preparation recipe;

identifying, for a beverage-generating location, one or more of the recipe generators based on an ability of the beverage-generating location to prepare the beverage based on ingredients available at individual beverage robots at the beverage-generating location;

receiving, from the beverage-generating location, a selection of a recipe generator; and

communicating the generated robot operating procedures to at least one beverage robot at the beverage-generating location to allow the at least one beverage robot to prepare the beverage according to the preparation recipe received from the selected recipe generator.

16. The method of example 15, wherein receiving the selection of the recipe generator comprises:

displaying, on a user interface, a plurality of panels, wherein each panel includes a name and a match recommendation rating of one of the plurality of recipe generators;

receiving, via the user interface, a selection of one of the panels corresponding to the selected recipe generators;

displaying, on the user interface, a geographic information and a plurality of markers on the geographic information, wherein each marker represents one of a plurality of beverage-generating locations;

displaying, on the user interface, a set of operating guidelines from the selected recipe generator;

receiving, from the beverage-generating location, an application to apply to the selected recipe generator; and

communicating, to the selected recipe generator, the received application.

17. The method of example 16, wherein the plurality of markers comprises:

a first set of markers indicative of store locations owned by the beverage-generating location and currently selling the selected recipe generator;

a second set of markers indicative of store locations owned by the beverage-generating location and not currently selling the selected recipe generator; and

a third set of markers indicative of store locations not owned by the beverage-generating location and currently selling the selected recipe generator.

18. A method for matching a beverage brand with a beverage vendor, the method comprising:

receiving, from the beverage brand, ingredient management details and a beverage production recipe, wherein the ingredient management details include supplier information, ingredient information, and end product information, wherein the beverage production recipe specifies steps for producing a beverage;

generating robot operating procedures based on the received beverage production recipe, wherein the robot operating procedures comprise operating instructions for a beverage robot to produce the beverage according to the received beverage production recipe;

receiving, from the beverage brand, a set of operating guidelines;

matching the beverage brand with the beverage vendor;

communicating, to the matched beverage vendor, the ingredient management details and the set of operating guidelines; and

communicating, to a beverage robot at the matched beverage vendor, the generated robot operating procedures.

19. The method of example 18, wherein matching the beverage brand with the beverage vendor comprises:

displaying, on a user interface of the beverage brand, a geographic information and a plurality of markers on the geographic information, wherein each marker represents one of a plurality of beverage vendors;

receiving, via the user interface, a selection of one or more of the plurality of markers;

displaying, on the user interface, a list of a subset of the plurality of beverage vendors corresponding to the selected one or more markers;

receiving, via the user interface, a selection of one of the subset of beverage vendors included on the list;

displaying, on the user interface, a local-level view of the selected beverage vendor;

receiving, from the beverage brand, an application to apply to the selected beverage vendor; and

communicating, to the selected beverage vendor, the received application.

20. The method of example 19, wherein displaying the geographic information and the plurality of markers comprises:

determining a match recommendation rating for each of the plurality of beverage vendors;

identifying one or more of the beverage vendors based on the match recommendation ratings of the beverage vendors; and

displaying, on the user interface and over the geographic information, one or more of the match recommendation ratings corresponding to the identified one or more beverage vendors.

21. The method of example 19 or example 20, wherein the plurality of markers comprises:

a first set of markers indicative of beverage vendors from which the beverage brand is awaiting approval;

a second set of markers indicative of beverage vendors that have approved the beverage brand; and

a third set of markers indicative of beverage vendors that are not accepting applications.

22. The method of any one of examples claim 19–21, further comprising:

displaying, on the user interface, an enlarged geographic information simultaneously with the list of the subset of beverage vendors, wherein the enlarged geographic information is sized to display the selected one or more markers.

23. The method of any one of examples 19–22, wherein displaying the local-level view of the selected beverage vendor comprises:

displaying, on the user interface and over the local-level view, (i) a competitor marker indicative of a competitor vendor located in proximity to the selected beverage vendor and (ii) a competitive analysis report corresponding to the competitor vendor.

24. The method of any one of example 18–23, wherein matching the beverage brand with the beverage vendor comprises:

displaying, on a user interface of the beverage vendor, a plurality of panels, wherein each panel includes a name and a match recommendation rating of one of a plurality of beverage brands;

receiving, via the user interface, a selection of one of the panels;

displaying, on the user interface, a geographic information and a plurality of markers on the geographic information, wherein each marker represents one of a plurality of store locations;

displaying, on the user interface, the set of operating guidelines corresponding to the selected beverage brand;

receiving, from the beverage vendor, an application to apply to the selected beverage brand; and

communicating, to the selected beverage brand, the received application.

25. The method of example 24, wherein the plurality of markers comprises:

a first set of markers indicative of store locations owned by the beverage vendor and currently selling the selected beverage brand;

a second set of markers indicative of store locations owned by the beverage vendor and not currently selling the selected beverage brand; and

a third set of markers indicative of store locations not owned by the beverage vendor and currently selling the selected beverage brand.

26. The method of any one of examples 18–25, further comprising:

receiving, from a plurality of beverage brands, a plurality of bids for the beverage vendor; and

communicating, to the beverage vendor, (i) the plurality of bids, (ii) metrics of the plurality of beverage brands, and (iii) criteria for evaluating the plurality of bids.

27. The method of any one of examples 18–26, further comprising:

receiving, from a plurality of beverage vendors, a plurality of bids for the beverage brand; and

communicating, to the beverage brand, (i) the plurality of bids, (ii) metrics of the plurality of beverage vendors, and (iii) criteria for evaluating the plurality of bids.

28. The method of any one of examples 18–27, wherein the supplier information includes a list of suppliers providing ingredients for producing the beverage according to the received beverage production recipe.

29. The method of any one of examples 18–28, wherein the ingredient information includes at least one of cost, shelf life, cleaning frequency, pH level, water activity, or proportions associated with ingredients for producing the beverage according to the received beverage production recipe.

30. The method of any one of examples 18–29, wherein the end product information includes at least one of serving size, weight, or suggested retail price associated with the beverage to be produced according to the received beverage production recipe.

31. The method of any one of examples 18–30, wherein the set of operating guidelines includes marketing guidelines specifying how marketing materials should appear and where the marketing materials should be positioned.

32. A non-transitory computer-readable storage medium storing instructions that, when executed by a computing system, cause the computing system to perform operations for controlling operation of a beverage matching system, the operations comprising:

receiving, from a beverage brand, ingredient management details and a beverage production recipe, wherein the ingredient management details include supplier information, ingredient information, and end product information, wherein the one or more beverage production recipes specify steps for producing one or more beverages;

generating robot operating procedures based on the received beverage production recipe, wherein the robot operating procedures comprise operating instructions for a beverage robot to produce a beverage according to the received beverage production recipe;

receiving, from the beverage brand, a set of operating guidelines;

matching the beverage brand with a beverage vendor;

communicating, to the matched beverage vendor, the ingredient management details and the set of operating guidelines; and

communicating, to a beverage robot at the matched beverage vendor, the generated robot operating procedures.

33. The non-transitory computer-readable storage medium of example 32, wherein matching the beverage brand with the beverage vendor comprises:

displaying, on a user interface of the beverage brand, a geographic information and a plurality of markers on the geographic information, wherein each marker represents one of a plurality of beverage vendors;

receiving, via the user interface, a selection of one or more of the plurality of markers;

displaying, on the user interface, a list of a subset of the plurality of beverage vendors corresponding to the selected one or more markers;

receiving, via the user interface, a selection of one of the subset of beverage vendors included on the list;

displaying, on the user interface, a local-level view of the selected beverage vendor;

receiving, from the beverage brand, an application to apply to the selected beverage vendor; and

communicating, to the selected beverage vendor, the received application.

34. The non-transitory computer-readable storage medium of example 32, wherein matching the beverage brand with the beverage vendor comprises:

displaying, on a user interface of the beverage vendor, a plurality of panels, wherein each panel includes a name and a match recommendation rating of one of a plurality of beverage brands;

receiving, via the user interface, a selection of one of the panels;

displaying, on the user interface, a geographic information and a plurality of markers on the geographic information, wherein each marker represents one of a plurality of store locations;

displaying, on the user interface, the set of operating guidelines corresponding to the selected beverage brand;

receiving, from the beverage vendor, an application to apply to the selected beverage brand; and

communicating, to the selected beverage brand, the received application.

35. The non-transitory computer-readable storage medium of any one of examples 32–34, wherein the operations further comprise:

receiving, from a plurality of beverage brands, a plurality of bids for the beverage vendor; and

communicating, to the beverage vendor, (i) the plurality of bids, (ii) metrics of the plurality of beverage brands, and (iii) criteria for evaluating the plurality of bids.

36. The non-transitory computer-readable storage medium of any one of examples 32–35, wherein the operations further comprise:

receiving, from a plurality of beverage vendors, a plurality of bids for the beverage brand; and

communicating, to the beverage brand, (i) the plurality of bids, (ii) metrics of the plurality of beverage vendors, and (iii) criteria for evaluating the plurality of bids.

37. The non-transitory computer-readable storage medium of any one of examples 32–36, wherein the set of operating guidelines includes marketing guidelines specifying how marketing materials should appear and where the marketing materials should be positioned.

### VII.Conclusion

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing concentrations, shear strength, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

We claim:

1. A method for operating a network of production robots, the method comprising:
receiving, from a recipe generator, a preparation recipe associated with a beverage from the recipe generator, wherein the preparation recipe specifies steps for preparing the beverage at an individual beverage robot from the network of beverage robots;
generating robot operating procedures based on the received preparation recipe, wherein the robot operating procedures comprise operating instructions for the individual beverage robot to prepare the beverage according to the received preparation recipe;
identifying one or more beverage-generating locations available to prepare the beverage;
receiving, from the recipe generator, a selection of a beverage-generating location; and
communicating the generated robot operating procedures to at least one beverage robot at the selected beverage-generating location to allow the at least one beverage robot to prepare the beverage according to the preparation recipe.

2. The method of claim 1, wherein receiving the selection of the beverage-generating location comprises:
displaying, on a user interface, a geographic information and a plurality of markers on the geographic information, wherein each marker represents one or more of the identified one or more beverage-generating locations;
receiving, via the user interface, a selection of one or more of the plurality of markers;
displaying, on the user interface, a list of a subset of the beverage-generating locations corresponding to the selected one or more markers;
receiving, via the user interface, a selection of one of the subset of the beverage-generating locations included on the list;
displaying, on the user interface, a local-level view of the selected one of the subset of the beverage-generating locations;
receiving, from the recipe generator, an application to apply to the selected one of the subset of the beverage-generating locations; and
communicating, to the selected one of the subset of the beverage-generating locations, the received application.

3. The method of claim 2, wherein displaying the geographic information and the plurality of markers comprises:
determining a match recommendation rating for each of the identified one or more beverage-generating locations;
selecting one or more of the identified one or more beverage-generating locations based on the match recommendation ratings of the beverage-generating locations; and
displaying, on the user interface and over the geographic information, one or more of the match recommendation ratings corresponding to the selected one or more beverage-generating locations.

4. The method of claim 2, wherein the plurality of markers comprises:
a first set of markers indicative of beverage-generating locations from which the recipe generator is awaiting approval;
a second set of markers indicative of beverage-generating locations that have approved the recipe generator; and
a third set of markers indicative of beverage-generating locations that are not accepting applications.

5. The method of claim 2, further comprising:
displaying, on the user interface, an enlarged geographic information simultaneously with the list of the subset of the beverage-generating locations, wherein the enlarged geographic information is sized to display the selected one or more markers.

6. The method of claim 2, wherein displaying the local-level view of the selected beverage-generating location comprises:
displaying, on the user interface and over the local-level view, (i) a competitor marker indicative of a competitor beverage-generating location located in proximity to the selected beverage-generating location and (ii) a competitive analysis report corresponding to the competitor beverage-generating location.

7. The method of claim 1, further comprising:
receiving, from a plurality of recipe generators including the recipe generator, a plurality of bids for one of the beverage-generating locations; and
communicating, to the one of the beverage-generating locations, (i) the plurality of bids, (ii) metrics of the plurality of recipe generators, and (iii) criteria for evaluating the plurality of bids.

8. The method of claim 1, further comprising:
receiving, from the one or more beverage-generating locations, a plurality of bids for the recipe generator; and
communicating, to the recipe generator, (i) the plurality of bids, (ii) metrics of the one or more beverage-generating locations, and (iii) criteria for evaluating the plurality of bids.

9. The method of claim 1, further comprising:
receiving, from the recipe generator, supplier information including a list of suppliers providing ingredients for producing the beverage according to the received preparation recipe.

10. The method of claim 1, further comprising:
receiving, from the recipe generator, ingredient information including at least one of cost, shelf life, cleaning frequency, pH level, water activity, or proportions associated with ingredients for producing the beverage according to the received preparation recipe.

11. The method of claim 1, further comprising:
receiving, from the recipe generator, end product information including at least one of serving size, weight, or suggested retail price associated with the beverage to be produced according to the received preparation recipe.

12. The method of claim 1, wherein identifying the one or more beverage-generating locations available to prepare the beverage is based at least in part on a category of each of the one or more beverage-generating locations.

13. The method of claim 1, wherein identifying the one or more beverage-generating locations available to prepare the beverage is based at least in part on ingredients available at individual beverage robots at each of the one or more beverage-generating locations.

14. A method for operating a network of production robots, the method comprising:
receiving, from a plurality of recipe generators, a plurality of preparation recipes each associated with a beverage from the recipe generators, wherein the preparation recipes each specifies steps for preparing the beverage at an individual beverage robot from the network of beverage robots;
generating robot operating procedures based on the received preparation recipe, wherein the robot operating procedures comprise operating instructions for the individual beverage robot to prepare the beverage according to the received preparation recipe;
identifying, for a beverage-generating location, one or more of the recipe generators based on an ability of the beverage-generating location to prepare the beverage;
receiving, from the beverage-generating location, a selection of a recipe generator; and
communicating the generated robot operating procedures to at least one beverage robot at the beverage-generating location to allow the at least one beverage robot to prepare the beverage according to the preparation recipe received from the selected recipe generator.

15. The method of claim 14, wherein receiving the selection of the recipe generator comprises:
displaying, on a user interface, a plurality of panels, wherein each panel includes a name and a match recommendation rating of one of the plurality of recipe generators;
receiving, via the user interface, a selection of one of the panels corresponding to the selected recipe generators;
displaying, on the user interface, a geographic information and a plurality of markers on the geographic information, wherein each marker represents one of a plurality of beverage-generating locations;
displaying, on the user interface, a set of operating guidelines from the selected recipe generator;
receiving, from the beverage-generating location, an application to apply to the selected recipe generator; and
communicating, to the selected recipe generator, the received application.

16. The method of claim 15, wherein the plurality of markers comprises:
a first set of markers indicative of store locations owned by the beverage-generating location and currently selling the selected recipe generator;
a second set of markers indicative of store locations owned by the beverage-generating location and not currently selling the selected recipe generator; and
a third set of markers indicative of store locations not owned by the beverage-generating location and currently selling the selected recipe generator.

17. A non-transitory computer-readable storage medium storing instructions that, when executed by a computing system, cause the computing system to perform operations for controlling operation of a beverage matching system, the operations comprising:
receiving, from a beverage brand, ingredient management details and a beverage production recipe, wherein the ingredient management details include supplier information, ingredient information, and end product information, wherein the beverage production recipe specifies steps for producing a beverage;
generating robot operating procedures based on the received beverage production recipe, wherein the robot operating procedures comprise operating instructions for a beverage robot to produce the beverage according to the received beverage production recipe;
receiving, from the beverage brand, a set of operating guidelines;
matching the beverage brand with a beverage vendor;
communicating, to the matched beverage vendor, the ingredient management details and the set of operating guidelines; and
communicating, to a beverage robot at the matched beverage vendor, the generated robot operating procedures.

18. The non-transitory computer-readable storage medium of claim 17, wherein matching the beverage brand with the beverage vendor comprises:
displaying, on a user interface of the beverage brand, a geographic information and a plurality of markers on the geographic information, wherein each marker represents one of a plurality of beverage vendors;
receiving, via the user interface, a selection of one or more of the plurality of markers;
displaying, on the user interface, a list of a subset of the plurality of beverage vendors corresponding to the selected one or more markers;
receiving, via the user interface, a selection of one of the subset of beverage vendors included on the list;
displaying, on the user interface, a local-level view of the selected beverage vendor;
receiving, from the beverage brand, an application to apply to the selected beverage vendor; and
communicating, to the selected beverage vendor, the received application.

19. The non-transitory computer-readable storage medium of claim 17, wherein matching the beverage brand with the beverage vendor comprises:
displaying, on a user interface of the beverage vendor, a plurality of panels, wherein each panel includes a name and a match recommendation rating of one of a plurality of beverage brands;
receiving, via the user interface, a selection of one of the panels;
displaying, on the user interface, a geographic information and a plurality of markers on the geographic information, wherein each marker represents one of a plurality of store locations;
displaying, on the user interface, the set of operating guidelines corresponding to the selected beverage brand;
receiving, from the beverage vendor, an application to apply to the selected beverage brand; and
communicating, to the selected beverage brand, the received application.

20. The non-transitory computer-readable storage medium of claim 17, wherein the operations further comprise:
receiving, from a plurality of beverage brands, a plurality of bids for the beverage vendor; and
communicating, to the beverage vendor, (i) the plurality of bids, (ii) metrics of the plurality of beverage brands, and (iii) criteria for evaluating the plurality of bids.
